(19) United States
(12) Patent Application Publication
(10) Pub. No.: US 2016/0075953 A1
(43) Pub. Date: Mar. 17, 2016

(54) Oil shale retorting

(71) Applicants: Andrew James Maxwell, Brighton, UT (US); Gregory Gordon Gold, Draper, UT (US); John James Maxwell, The Gap (AU)

(72) Inventors: Andrew James Maxwell, Brighton, UT (US); Gregory Gordon Gold, Draper, UT (US); John James Maxwell, The Gap (AU)

(73) Assignee: Guardsman Group, LLC. A Utah Limited Liability Company, Brighton, UT (US)

(21) Appl. No.: 14/121,525

(22) Filed: Sep. 15, 2014

(51) Int. Cl. C10G 32/02; H05B 6/10; E21B 43/24; C10G 1/04

(52) U.S. Cl. CPC C10G 32/02; C10G 1/045; H05B 6/108; E21B 43/24

(57) ABSTRACT

Pyrolysis of oil shale or removal of valuable hydrocarbons from other hydrocarbon-containing materials is achieved through heating of induction-heatable objects which can transfer heat to the oil shale or other hydrocarbon-containing material in a dynamic process matrix. The induction-heatable materials should be conductive and resistive. The induction-heatable materials may also be resistive. The induction-heatable objects are exposed to a rapidly-changing magnetic field which causes current to flow within the induction-heatable objects. Resistive heating results, which generates heat within the induction-heatable objects. If the induction-heatable objects are also magnetic, then heat is secondarily generated within them by magnetic hysteresis. The induction-heatable objects are mixed with oil shale feedstock to form a dynamic process matrix either before or after they are heated by induction heating. The dynamic process matrix resides within a retort for a desired period of time heat is transferred from the induction-heatable objects to oil shale particles in the matrix through the mechanism of conductance due to intimate contact between the induction-heatable objects of and oil shale in the dynamic process matrix. Pyrolysis of the oil shale occurs and valuable hydrocarbons can be collected. The process is dynamic because the induction-heatable objects contact different oil shale particles within the matrix at different times to achieve relatively even heat distribution within the matrix. Any hydrocarbon-containing materials may be subjected to this treatment.

### CLAIM FOR PRIORITY

This patent application claims benefit of U.S. Provisional Patent Application Ser. No. 61/964,004 filed on Dec. 20, 2013.

### BACKGROUND

Oil is known to be an extremely valuable resource, and reserves of oil are highly sought. Consequently, attempts to recover oil in all of its forms have been made for many decades. Traditional oil well drilling continues to be employed with great effect, but traditional underground petroleum deposits of crude oil that can be pumped to the surface are in short supply. Consequently, there is a great need for alternative sources of the hydrocarbons found in petroleum.

Petroleum is found in underground deposits other than crude oil. Oil shale represents vast reserves of petroleum, but extraction of usable oil from the deposits is very difficult and costly using current technology. Many efforts to develop those resources have been made, but with only limited success due to the economics of applying heat to the resource in order to extract hydrocarbons from it, and due to pollution which results. Oil sands and tar sands are another type of non-traditional or alternative sources of oil that also face economic and technical difficulties for large-scale commercial exploitation.

Some regions of the world contain enormous deposits of oil in the form of oil shale, but shale presents a difficult problem for the oil industry. While the total quantity of oil trapped in an oil shale deposit may be large and can therefore represent significant economic value, recovery of the oil in a manner that is both technically feasible and economically viable without being environmentally destructive has been difficult to achieve. The inventions to which this patent application pertains address these difficulties in the prior art, and the inventions can applied to tar sands, oil sands, other non-liquid deposits of hydrocarbons, and other materials containing valuable hydrocarbons.

In oil shale, hydrocarbons are locked into the shale formation in a high molecular weight material called kerogen that is non-flowable at room temperature. Extraction of oil from oil shale has generally been performed by pyrolysis, hydrogenation and thermal dissolution. The most common technologies apply heat to the oil shale in order to cause it to undergo pyrolysis, break up the kerogen and release hydrocarbons from the oil shale. Depending on the technology being used, oil may be removed from oil shale either below ground or above ground. Above-ground systems are more common, and efficiency of extraction of usable oil from oil shale in above-ground processes tends to be greater. Above-ground processing of oil shale after it has been mined is referred to as “ex situ processing”, and processing of oil shale underground in its formation is referred to as “in situ processing”.

Oil locked within oil shale in the form known as kerogen can be removed through pyrolysis by heating oil shale, typically in the absence of oxygen, until the kerogen decomposes into liquid hydrocarbons, condensable shale oil vapors and/or non-condensable combustible oil shale gas. Liquid oil, oil vapors and oil shale gas are then collected and cooled, causing the gaseous hydrocarbon products to condense. Generation of heat for pyrolysis can be achieved by an external heat source (such as a natural gas furnace or other heating assemblies), or by burning oil still contained in spent oil shale and oil shale ash. Crushing oil shale feedstock increases its surface area for more efficient extraction of oil. Non-efficient use of energy to heat oil shale in order to cause pyrolysis is an enormous expense for oil shale projects, and can render a project non-viable.

Pyrolysis is also called retorting, and the vessel in which it is conducted is called a retort. Retorts may be constructed horizontally or vertically, depending on the technology being employed. Use of a retort traditionally requires removal of oil shale from an oil shale deposit and processing it ex situ above ground. Some oil shale deposits have above-ground outcrops that can be accessed economically. Often oil shale is typically found underground where expensive underground mining techniques or strip mining must be employed.

Heating oil shale in order to conduct pyrolysis requires exposure of the oil shale to an appropriate heat source. In the prior art, heat was provided internally in the retort, such as by gas combustion (internal combustion), hot recycled oil shale materials (sometimes still burning), conduction through a wall of the retort, externally-generated hot gas, reactive fluids and volumetric heating.

Common drawbacks of internal combustion technologies are that combustible oil shale gas is diluted by combustion gases and particles smaller than 10 millimeters (0.4 in) cannot be processed. Uneven distribution of gas across the retort can result in blockages when hot spots cause particles to fuse or disintegrate. Gaseous heating is inefficient because it allows much of the heat generated to escape through venting rather than transferring heat to the oil shale being processed. In addition, any burning at the mine site produces pollutants which are an environmental and a regulatory problem.

Hot recycled solids technologies deliver heat to the oil shale by recycling hot solid particles, typically oil shale ash. These technologies usually employ rotating kiln retorts or fluidized bed retorts, fed by fine oil shale particles generally having a diameter of less than 10 millimeters. The recycled particles are heated in a separate chamber or vessel and then mixed with the raw oil shale to cause the shale to decompose. Oil vapor and shale oil gas are separated from the solids and cooled to condense and collect the oil. Heat recovered from the combustion gases and shale ash may be used to dry and preheat the raw oil shale before it is mixed with the hot recycled solids. These technologies can be environmentally unfriendly due to emission of noxious gases.

Conduction-through-a-wall technologies transfer heat to the oil shale by contacting the oil shale with a hot wall of a retort, and then allowing pyrolysis to occur within the retort. Condensable oil and gas are collected as mentioned above. A general drawback of conduction-through-a wall-technologies is that the retorts are very costly when scaled-up for commercial use, due to the large amount of expensive high-temperature alloys used to make the retort. Also, the retorts which could be used on a commercial scale using this technology tend to be extremely large and require a high capital investment. The energy demands of this technology make it expensive to operate, yet heat transfer using these technologies is generally slow and inefficient. In addition, differences in temperature near the side of the retort compared to in the center of the retort lead to inefficiency and result in incomplete pyrolysis of the oil shale.

Externally generated hot gas technology processes oil shale lumps in a vertical retort with gases being heated outside the retort and then moved through the retort to cause pyrolysis. With this system, fine particles of oil shale cannot be processed because they block gas flow, so fine particles must be removed from the oil shale feedstock before it is fed into a retort. Such sorting of oil shale can be costly. Also, heat may cause combustion of spent oil shale which will burn off valuable fuels. And gaseous heating loses a large amount of heat through venting rather than transferring it to the oil shale, causing high energy expenditures and low efficiency.

Oil trapped within oil shale deposits resists removal by use of solvents. However, there has been some success in using supercritical fluids to remove oil from oil shale. A supercritical fluid is a substance where temperature and pressure bring it above its critical point where distinct liquid and gas phases do not exist. A supercritical fluid can effuse through solids like a gas, and dissolve materials like a liquid. Reactive fluids systems have not been implemented commercially, are very complex, and very expensive.

Another technology that can be used to remove oil from oil shale is plasma gasification. Oil shale is bombarded by ions to crack kerogen molecules, thus removing the oil from oil shale. This technology also has not been implemented commercially and would be very expensive.

The following paragraphs describe some specific prior art attempts to remove hydrocarbons from oil shale. Notwithstanding the media excitement surrounding these technologies and projects that use them, these attempts have not shown the type of success which would lead them to be implemented in the many oil shale deposits around the world that are presently sitting idle and are not being mined due to lack of an attractive retorting technology. The prior art technologies can be expensive to implement, expensive to operate, inefficient in terms of the percentage of oil recovered, and environmentally harmful. Some prior art technologies have left spent oil shale in a harmful state at the time of disposal, including spent shale that is still on fire when deposited in a waste area.

Hot recycled solids technology can be used to process ore pieces of all sizes. It uses a single chamber horizontal retort and moves material horizontally through the various stages of processing. The huge size of the retort and the cost of its construction are barriers to any implementation of this technology. The Alberta Taciuk Process or ATP an example of this technology, but it has been without success in the past. In 1999 it was briefly used in Australia, but was shut down and abandoned due to environmental problems. In 2002, it was tested in Estonia, but never adopted. A similar result was reached during a test in Calgary, Alberta. A plant was built in China in 2010 to use ATP, but it has never been operational and appears to be unsuccessful.

Another prior art system is the Fushun Retort in China. It uses an internal combustion process with external gas supplementation. A vertical cylinder shaft retort that is about 10 meters high is used to process oil shale in the size range of 10-75 mm. Particles finer than 10 mm render the system non-operational. In the Fushun Retort, pyrolysis occurs in the top half of the vessel and combustion of coke occurs in the lower half.

Through this process, gases from the heated oil rise in the vessel to partially fuel the process. As the oil shale is broken down, gases which leave the retort are condensed to yield oil. The oil must be re-heated before re-inserting into the retort. This system has a 65% of Fischer assay yield (65% recovery), which is not considered efficient. Oxygen present in the retort substantially reduces oil yield. Gases produced by this process include a significant proportion of gaseous nitrogen, which is considered undesirable because of the cost of separation from other saleable gases. The Fushun process uses six to seven barrels of water per single barrel of oil produced, making it problematic for implementation in drier areas and causing significant environmental concerns. Noxious gases are emitted. The serious economic, technical and environmental issues associated with the Fushun process have caused oil companies to rule it out for future projects.

Yet another prior art technology is the Galoter Process or Galoter Retort. It uses recycled solids in a horizontal rotating kiln. Oil shale particles must be pre-processed to a size of less than 25 mm. Oil shale is mixed with hot ash from combusted, spent shale. The hot ash is combusted in a separate retort. This process has high thermal efficiency, and less pollution is produced than with internal combustion technologies (see above), but it still generates carbon dioxide, carbon disulfide, and calcium sulfide which are environmentally-unfriendly emissions. This technology uses significant volumes of water which creates an environmental problem. Therefore it does not appear that any new oil shale projects will be started using the Galoter Process.

A modification to the Galoter Process is the Enefit Process, developed by Enefit Outotec Technology of Estonia. It uses a fluidized bed furnace to pre-process the oil shale feedstock and a fluidized bed cooler for ash that fuels a waste heat boiler to generate electricity. The Enefit Process is an improvement over the Galtoter process in that it has improved thermal efficiency, displays more complete combustion, uses less water and provides more rapid processing of oil shale. However, it still yields substantial pollutants. Although Enefit has large land holdings containing oil shale in the United States, it has not implemented the Enefit Process for those holdings due to problems inherent in the Enefit Process.

In the prior art, the Paraho Process was used in Rifle, Colo. to process oil shale particles, provided that the particles were limited to those greater than 12 mm in size. Both direct and indirect heating methods are possible with the Paraho Process, although generally it is categorized as an internal combustion process with all of the waste and environmental problems that internal combustion pyrolysis systems entail. Paraho feeds oil shale of the correct size into the top of a retort via a rotating material distributor. The oil shale descends through the retort as a moving bed, and is heated by rising combustion gases lower in the retort. Oil vapor, oil shale gas and spent oil shale are produced. Gases are removed from the retort and processed separately into useful products and waste material. This system requires very large capital outlays, putting profitability of an oil shale facility using this technology very far in the future, even if the environmental and efficiency of this technology could be addressed. The industry is not embracing the Paraho process due to these problems.

Generalizations regarding some of the problems with prior art oil shale extraction technologies are discussed below.

Some prior art technologies recycle spent shale to preheat the new shale as it enters the retort vessel. This saves energy but results in problems with excessive wear, and grinding of the ash into very fine particles is expensive and then those particles are almost impossible to deal with from a material handling point of view.

Some prior art technologies use indirect conduction combined with convection gas heating. This has several disadvantages. Heating the outside of a processing vessel in order to transfer heat to materials inside the vessel by contact with the vessel wall results in a very small heating surface to material volume ratio and inefficient heat transfer. And evenly heating the material being processed is very difficult and/or very expensive to achieve. Also, heating with convection gas requires the separation of this gas from the product gases later in the process which poses both technical and economic problems. If combustion gas is used for heating, then the ratio of heating gas to product gas can be 100:1. These difficulties and inefficiencies, as well as environmental issues, cause these technologies to be undesirable.

Some prior art technologies use combustion of the shale itself to heat the oil extraction process. Problems in such a system include separation of the combustion gases from the product. The combustion creates massive amounts of CO and CO2 which must be removed. Inability to remove these gases causes coking of the ash and leaves slag within the retort. In addition, finite temperature control is very hard to achieve in such a system. And pollutants produced pose a significant problem for regulatory approval of projects using these technologies. Therefore these technologies are not considered viable for oil shale deposits that have not yet been developed.

Typical prior art technologies require long residence times for heating of the shale to achieve oil extraction. This reduces throughput and production volume, and is inefficient and costly.

Typical prior art technologies require very careful preparation of the feed stock oil shale prior to processing. This is time-consuming, costly, wasteful and difficult. Some prior art technologies processes provide limited control of exact heating temperatures. This results in fluctuation of produced volumes and variance in the ratios of what is produced. These variations lead to great inefficiencies, incomplete processing of materials, low yield, and economic non-feasibility.

Finally, all prior art technologies for removing oil from oil shale have a very high capital investment threshold before even optimistic economic projections would indicate that a plan is feasible. Due to the lack of proven operations, and the plethora of failed oil shale projects, it is very difficult to obtain the huge sums of capital needed to construct a plant using the prior art technologies.

Due to the problems with prior art technologies, enormous amount of oil trapped in oil shale deposits is waiting for the development of a viable technology before commercial exploitation of oil shale in western countries will be realistic. Encouragement and support of the oil shale industry by governmental agencies has not resulted in economic and environmental viability of prior art technologies for most oil shale deposits in the world. The exceptions are projects in the third world where massive amounts of pollution can be tolerated and government subsidies may be available. The industry awaits development of a new oil shale processing technology which is economically efficient and clean.

### SUMMARY

The invented processes, machines and methods are poised to bring the unrealized promise of oil shale as a mainstream energy source to fruition. Environmentally clean and energy-efficient induction heating of induction-heatable objects in a matrix with oil shale is used to transfer heat to oil shale that is in the matrix. The induction-heatable objects can be heated by induction heating before or after they are mixed with the oil shale to form a matrix. The induction-heatable objects can be heated prior to entry of the matrix to the retort, or while the matrix is in the retort, or both. Retorting can be dynamic, with the matrix moving through a retort while pyrolysis occurs, rather than residing in the retort for a long residence time. Spent oil shale from this process is not a harmful substance and can be discarded. Water is not needed and pollutants are not released to the atmosphere.

Further, heating of the induction-heatable objects may be performed dynamically by moving them through a coil, or moving the matrix through a coil, while induction heating of the induction-heatable objects occurs. Removal of valuable hydrocarbons from the retort occurs during and/or after pyrolysis. This general inventive concepts provides an energy-efficient process for removing hydrocarbons from oil shale.

Undesirable pollution from burning oil shale, or using hot gases from such burning shale, as found in some prior art processes, is completely avoided. Energy inputs are low when the inventions are used, and recovery of usable hydrocarbons is highly efficient and nearly complete. The input energy to heat conversion ratio is very efficient, and the cost of plant construction is very low compared to prior art alternatives. A high surface area of contact between induction-heatable objects and oil shale feedstock may be achieved, resulting in rapid heat transfer from the induction-heatable objects to the oil shale, and rapid pyrolysis of the oil shale. Fine temperature controls available for induction heating keep the temperature of the oil shale within a retort within a desired range, thus avoiding overheating or under-heating the oil shale. Finally, the inventions may implemented in mobile processing facilities, resulting in economical re-use of capital investments, reduced transportation costs, and less geographical disruption at an oil shale processing site.

The induction heating methods, structures and systems of the inventions offer easy and accurate control over the temperature of the hydrocarbon-containing material being processed through direct control of the current supplied to an induction coil which in turn results in very accurate control of the temperature of induction-heatable objects being used to heat oil shale. Increasing or decreasing current to the induction coil(s) results in very rapid temperature response from the induction-heatable objects.

Some prior art retorting processes, once started, cannot be stopped or can only be stopped over a long period of time. The invented processes can be stopped quickly simply by terminating power input the induction coil(s). This level of control is an important safety feature.

The inventions also allow retorting of oil shale without burning or degrading the desired hydrocarbons. The inventions allow a wide variety of materials to be heated to a desired temperature, and maintained at that temperature for any desired period of time by controlling the energy input to the induction coil or induction heater. The invented systems can be configured for continuous or batch processing, as desired. The invented processors are also scalable and easily multiplied for staged facility development. This keeps capital expenditures low and controllable, in contrast with prior art systems.

When the inventions are used, heating of the oil shale feedstock is rapid due to a large surface area of contact between the feedstock and induction-heatable objects. In addition, the induction-heatable objects heat up very rapidly when the induction coil(s) of the induction heater are powered. And the inventions can cause pyrolysis of oil shale in less than an hour, depending on the implementation.

Mixing of a feedstock with induction-heatable objects to create a dynamic process matrix which is then fed into a retort may be performed inside of or outside of a retort, and heating of the induction-heatable objects in the matrix may be performed inside of or outside of the retort. The induction-heatable objects are heated via a powered induction coil located around them but not in physical contact with them. Heat from the induction-heatable objects in the matrix is transferred to the feedstock primarily by intimate contact and conduction, causing departure of desired hydrocarbons from the feedstock. The desired hydrocarbons can then be collected, and the spent feedstock can be disposed of in an appropriate way. Due to complete or nearly-complete pyrolysis of the oil shale feedstock in the invented processes, spent oil shale which has been processed by the inventions is a non-hazardous material.

Another benefit of using induction heating is improved temperature level accuracy. When a desired temperature is reached, the induction coil can be powered down or powered off, in contrast to some prior art systems which burned material to create heat, and the burning was very difficult to control or stop, which resulted in overheating or under-heating of oil shale.

Another benefit of using induction heating is better ramp-up time control. The induction-heatable objects can be heated very quickly if desired, or very slowly, depending on how the induction coil is powered.

The dwell time, or time during which a hydrocarbon-containing material is exposed to hot induction-heatable objects may also be closely controlled in induction heating by adjusting power to the induction coil.

The invented processes are also easily adjusted to different temperature levels and different dwell times depending on the particular characteristics of the hydrocarbon-containing material being processed. For example, oil shale from Australia may require a higher level of heat for complete efficiency than oil shale from the United States, and those differences are easily accommodated by adjustments to the induction coil, adjustments to power supplied to the induction coil, and adjustments to the induction-heatable objects as used to retort such oil shale.

Other objects, features and advantages of the inventions are disclosed herein, or will be obvious to a reader of ordinary skill in the art upon reading this specification in light of the appended drawings.

### BRIEF DESCRIPTION OF DRAWINGS

FIG. 1 depicts an oil shale processing system that uses one or more induction heaters to heat induction-heatable objects of a dynamic process matrix within a retort and/or outside of a retort in order to transfer heat to oil shale and cause pyrolysis or oil shale within the retort.

FIG. 2 depicts oil shale processing where a dynamic process matrix of oil shale and a plurality of induction-heatable objects move into an induction heater where the plurality of induction-heatable objects in the dynamic process matrix are heated by electromagnetic induction, and then move into a retort for oil shale retorting.

FIG. 3 depicts oil shale processing where a dynamic process matrix of oil shale feedstock and a plurality of induction-heatable objects is created and then placed into a retort where an induction coil heats the induction-heatable objects to cause oil shale retorting. Recirculation of hot induction-heatable objects pre-heats the oil shale prior to creation of the dynamic process matrix.

FIG. 4 depicts a variation on the concept of FIG. 3, where multiple retorts are used in parallel.

FIG. 5 depicts a system that continuously feeds a dynamic process matrix of oil shale and a plurality of induction-heatable objects through an induction heater to cause pyrolysis of the oil shale.

FIG. 6 depicts a system in which a dynamic process matrix of oil shale feedstock and a plurality of induction-heatable objects is moved through a series of induction coils, each designed to efficiently and controllably raise the temperature of the induction-heatable objects and thus the temperature of oil shale feedstock in the matrix to cause oil shale retorting.

FIG. 7 depicts a system where a coil moves with respect to a stationary matrix of oil shale feedstock and induction-heatable objects in order to heat the induction-heatable objects in order to transfer heat to the oil shale within the matrix and cause oil shale retorting.

FIG. 8 depicts a continuous underground mining machine coupled with a mobile retort that can achieve great operational efficiency by in situ/underground removal and processing oil shale within the formation in which it is found thus minimizing transport of oil shale feedstock and spent oil shale.

FIG. 9 depicts more details of the example retort of FIG. 8 which separates valuable hydrocarbons from oil shale feedstock in situ.

### DETAILED DESCRIPTION

Various embodiments of the inventions are directed to pyrolysis of oil shale achieved by use of an induction-heated process matrix, in which a plurality of induction-heatable objects are heated by an induction heating method, and heat from the induction-heatable objects is transferred to oil shale feedstock in the matrix primarily by thermal conductance, causing pyrolysis of the oil shale which causes liquid or gaseous oil or hydrocarbons to exit the shale. The inventions include variations of such systems and devices and methods for using the same.

Induction heating creates heat in an electrically conductive object, such as a metal, but not limited to metals. The heating occurs by the mechanism of electromagnetic induction. In electromagnetic induction, an induction coil or electromagnet creates a rapidly changing magnetic field that induces eddy currents in a conductive object that is located within the interior of the coil. Eddy currents (also called Foucault currents) generated in the conductive object lead to Joule heating (also called ohmic heating or resistive heating) of the induction-heatable object. Electrical resistance within the conductive object opposes the flow of current through the object, creating heat. If the conductive object offers no resistance or little resistance to current flow, then resistive or ohmic heating will not occur or will have such a small effect that the object in question would not be suitable for use in the inventions.

Eddy currents typically flow in thin layers near the surface of an object being heated by electromagnetic induction. Consequently, that surface experiences tremendous current flow and will heat quickly and to a high temperature. This is called “skin effect”. As most embodiments of the inventions disclosed herein involve conduction of heat from the exterior surface of a plurality of induction-heated objects via intimate physical contact with feedstock in a dynamic process matrix, it is beneficial to have a hot outer surface on the induction-heated objects. Having a hot interior on the induction-heatable object is likely, although not necessarily required in all applications of the inventive concepts. A hot interior in the induction-heatable objects can assist in keeping the induction-heatable objects hot over a longer period of time to aid in complete pyrolysis of the oil shale. Typically up to 85% of the heat created in an induction-heated object is created by the skin effect, so generally smaller, thinner objects are easier to heat by induction, and therefore convert a greater percentage of input energy to heat.

The inventions typically will not include transfer of heat from induction-heatable objects to oil shale by having oil shale pass through the interior of induction-heatable objects, such as heated pipes or retorts having walls that are heated by induction. Such structures would come with the inefficiencies and heat distribution problems of conduction-through-a-wall technologies. Although it would be possible to use a plurality of hollow induction-heatable objects in the invented dynamic process matrix, and for some oil shale in the matrix to contact the interior of the hollow induction-heatable objects in order to receive heat from them, it is believed that the primary heat transfer mechanism of the inventions will be conductance from oil shale feedstock in the matrix contacting the exterior of heated induction-heatable objects in the matrix. As the dynamic process matrix experiences movement, shale particles and induction-heatable objects move with respect to each other, resulting in the dynamic nature of the matrix. Different oil shale particles can contact the induction-heatable objects at different times, heating the oil shale in the matrix more to a more uniform temperature distribution than prior art technologies.

The conductive and resistive material from which the induction-heatable objects are made may also generate heat by magnetic hysteresis if the induction-heatable objects are magnetic. Magnetic hysteresis is internal friction within the induction-heatable object due to the rapidly changing magnetic field created by an induction coil or electromagnet. The rapidly changing magnetic field forces the atomic dipoles of the material being heated to rapidly change and internal friction results. The internal friction creates heat, thus increasing temperature of the induction-heatable objects. Typically ferrous metals are subject to heating by magnetic hysteresis. Heating by this mechanism is called “hysteretic heating” and typically secondary and a lesser contributor to temperature increase of induction-heatable objects than ohmic or resistive heating.

In an induction heating system, materials with high electrical resistance will heat more quickly than materials with less electrical resistance. An example of this is the more rapid heating of steel via induction than aluminum.

Based on the foregoing, objects intended to be heated by induction for use in the inventions should be conductive and resistive. It may be helpful for them to be magnetic as well in order to take advantage of the secondary heating effect of magnetic hysteresis.

If it is not already clear, the reader should also be aware that in an induction heating system, the induction coil heats the induction-heatable objects without being in physical contact with them. This eases material movement considerations as contact with a coil would tend to block movement of the induction-heatable objects and oil shale within a matrix. Also note that using a dynamic matrix in which both the induction-heatable objects and the oil shale feed move with respect to each other, as opposed to a stationary heater, also eases material flow considerations. Although it would be possible to place a stationary induction-heatable object or objects in the path of material flow a hydrocarbon-containing feedstock due to heated created within the induction-heatable object by induction heating, such a system would impede material flow and would not lead to sufficiently rapid heating of the feedstock or even heat distribution of the feedstock. Likewise, although it is possible to move the dynamic process matrix past or around an electromagnet which creates a rapidly changing magnetic field around it in order to heat induction-heatable objects moving past the exterior of the electromagnet, such a system is also likely to have material flow issues as well as inefficiency issues. Therefore it is desired to move the induction-heatable objects through the interior of an induction coil in order to heat them. The induction-heatable objects may be heated in this way prior to creating of the dynamic process matrix, while the matrix is being formed, or after the matrix has been formed.

The frequency of current (typically AC) used in an inductive heater depends on the characteristics of the object to be heated. Factors to consider include object size, material type, coupling (the distance between the induction coil and the object to be heated) and the desired focal depth for heating. The term “coupling” does not mean physical contact, because in an induction heating system, there typically is no physical contact between the induction coil and the material to be heated.

In an induction heating system, the operating frequency needed for operation of the induction heater will be affected by the size of the induction-heatable objects. Generally, smaller objects to be heated benefit from a higher frequency (>50 kHz) current running through the induction heater coil, and larger objects benefit from a lower frequency (<10 kHz).

Examples of electrically conductive materials that can be induction-heated for use in the invented processes, equipment and systems include iron, steel, stainless steel, copper, aluminum, gold, silver, platinum, tungsten, zinc, nickel, lithium, tin, lead, titanium, carbon, carbon graphite, graphene, calcium, lithium, tin, steel, carbon steel, electrical steel, lead, manganin, constantan, stainless steel, mercury, nichrome, brass, bronze, electro-ceramics, conductive liquids, conductive gases, plasmas, alloys, combinations and mixtures thereof and others.

Magnetic materials are easily heated by an induction coil to any temperature that is below their Curie point or Curie temperature. However, heating a material above its Curie point requires more energy, is more difficult and is less energy-efficient overall. The Curie point of a material is the temperature at which the material undergoes a sharp change in its magnetic properties. Specifically, the Curie temperature of a material is the temperature at which there is a transition between the ferromagnetic and paramagnetic phases of the material. Below the Curie point, the material is magnetic. Above the Curie point, the material is purely paramagnetic. Heating a material above its Curie point results in loss of the secondary heating effect known as magnetic hysteresis.

The Curie point of a material can be important in induction heating because below the Curie point the material heats rapidly when within a powered induction coil. But it may be difficult to increase the temperature of the material to a level above its Curie point using induction, or at least such increase in temperature will come at a greater energy cost. Therefore it may be desirable to choose an induction-heatable objects that have a Curie point above the temperature required for pyrolysis of a particular oil shale or removal of hydrocarbons from other hydrocarbon-containing feedstock.

It is also possible to use Curie temperature to control the upper temperature of the induction-heatable objects, and therefore create a temperature ceiling to which oil shale or other hydrocarbon-containing feedstock in the dynamic process matrix is exposed. For example, steel has a lower Curie temperature than nickel alloys, so a lower upper temperature limit could be achieved by use of steel for the induction-heatable objects than by use of nickel alloys for the induction-heatable objects. This can be desirable because if oil shale or other hydrocarbon-containing materials in the feedstock of the matrix are heated to too high a temperature, unwanted degradation of the hydrocarbon products proposed to be extracted from the feedstock may occur. Alternatively, if too low a temperature is achieved in the dynamic process matrix, incomplete pyrolysis of the oil shale may result. Using Curie temperature of the induction-heatable objects to impose an upper limit on the heat in the dynamic process matrix provides a natural temperature control achieved by selection of materials present in the induction-heatable objects rather than by manual or computerized electrical control of the induction coil, although both may be used together.

In the past, induction heating was typically used to heat and cause changes to a work piece. For example, a piece of metal could be heated by electromagnetic induction prior to forging or heat treating. Or two pieces of metal could be brazed together using heat produced in the metals by an induction heater. Prior art induction heating typically heated the work piece in order to cause some changes in it, often measurable physical changes. In contrast, in the inventions, no changes to the induction-heatable objects is intended. Instead, the induction-heatable objects are heated for the purpose of transferring the heat to a third part feedstock present within a dynamic process matrix that includes the induction-heatable objects. Within the dynamic process matrix, induction-heatable objects contact particles of the feedstock in order to transfer heat to the feedstock by conduction. Transfer of heat by other mechanisms such as convection or thermal radiation can be performed as well. The feedstock is typically a hydrocarbon-containing material, but can be other material. Further, the reason for using a matrix of induction-heatable objects and feedstock particles is because the feedstock is not sufficiently conductive for induction heating to operate on it effectively without the presence of induction-heatable objects that are a different substance than the feedstock in the matrix. Consequently, if it is desired to heat the feedstock by induction heating, use of induction-heatable objects within the matrix to transfer heat to the feedstock in the matrix is almost always necessary. Another way to say this is that simply moving oil shale past or through a powered induction coil will not have the desired effect of retorting oil shale completely and in an energy-efficient manner.

The prior art does not disclose induction heating of a plurality induction-heatable objects within a dynamic process matrix, or prior to forming a dynamic matrix of induction-heatable objects and a hydrocarbon-containing material, in order to cause the induction-heatable objects to increase in temperature and then transfer heat to the hydrocarbon-containing material in order to cause hydrocarbons to exit that material.

It may be desirable to use induction-heatable objects that have high thermal conductively in order to cause rapid transfer or conduction of heat from induction-heatable objects to oil shale. Thermal conductivity is the ability to of an object or material to conduct heat to another object or material. Thermal conductivity is measured in units “k” of Btu/(hr ° F. ft). The thermal conductivity of various materials can be found in standard reference sources to which the reader can refer when selecting the material(s) of induction-heatable objects for a particular implementation of the inventions. For example, it may be desired to use induction-heatable objects that have a thermal conductivity above 15 k, above 20 k, above 30K above, 40 k, above 50 k or otherwise.

Note that if a hydrocarbon-containing material is already present with a sufficient quantity of induction-heatable objects within it, such used tires that have steel belts, then it would not be necessary to perform the step of adding induction-heatable objects to form the desired a matrix, as the feedstock already presents itself as a matrix of induction-heatable objects and hydrocarbon-containing material. However, hydrocarbon-containing materials that are also heatable directly with an induction material are not common, so transfer of heat from externally-added induction-heatable objects to the hydrocarbon-containing feedstock to form a dynamic process matrix is necessary in most applications of the inventive concepts. In addition, the induction-heatable objects that are already present with a hydrocarbon-containing material, such as used tires with steel belts, may not be present in sufficient quantity, or of a desired size, or of a desired composition, or of a desired shape to perform the heat transfer desired. If that is the case, then addition of induction-heatable objects to the matrix may be necessary or desirable notwithstanding the presence of induction-heatable substances already in the feedstock.

After the induction-heatable objects are heated by induction heating, heat transfer from the induction-heated objects to a feedstock of a hydrocarbon-containing material (such as oil shale) within the dynamic process matrix occurs. Primarily this heat transfer occurs via conduction due to physical contact between the induction-heatable objects and the hydrocarbon-containing feedstock material. Increasing the surface area of contact between the two increases the opportunity for heat transfer via conduction. In addition, some transfer of heat from the induction-heatable objects may occur due to radiant heating based on variables such as surface area, material characteristics and surface finish. Convection can also be a source of heat transfer, especially if hot gases within a retort that are produced by induction heating of the feedstock in the matrix are then circulated within the retort, such as by a fan. Therefore although the inventions are expected to primarily transfer heat from a plurality of induction-heatable objects to feedstock particles within a dynamic process by conduction due to different feedstock particles contacting different induction-heatable objects within the matrix at different times, heating of the feedstock in the matrix can also occur by either convection or radiant heating, or both.

Consideration should be given to the introduction of catalysts or reagents or conditions that will improve recovery of oil from a hydrocarbon-containing material, such as oil shale. Many catalysts and reagents are known in chemistry, and selection of a particular catalyst or reagent for a particular implementation of the inventive concepts is left to the party performing the implementation. Without limiting the generality of the foregoing, hydrogen, nitrogen and other material and substances can also be used as a catalyst or reagent in order to improve hydrocarbon yield. Other catalysts that could be used are cobalt and molybdenum, but the inventive concepts are not limited to the use of such catalysts or reagents.

Use of a gas atmosphere in a retort processing a hydrocarbon-containing material according to the inventive concepts may increase hydrocarbon yield or speed the reactions involved in removal of hydrocarbon from the feedstock material. Examples of a gas atmosphere used for this purpose can include hydrogen and nitrogen.

Further, use of or addition of a liquid to the interior of a retort can be utilized to improve yield or speed removal of hydrocarbons from a feedstock. Liquid can be used as a catalyst, as a reagent, as a heat transfer medium, or even as an induction-heatable material.

Another technique that may be used to speed hydrocarbon removal or increase yield is pressurizing the interior of the retort. Pressure can be used to improve reactions or to physically drive hydrocarbons from the feedstock. Alternatively, negative pressure or a vacuum may be used in an attempt to draw hydrocarbons from the feedstock. Combinations of the above and other techniques can be utilized to speed removal of hydrocarbons from a feedstock or to increase yield. In addition, such techniques may also be used to convert undesirable emissions from the processes used into a harmless state.

In an example embodiment of the invented processes, induction-heatable objects can be removed from the dynamic process matrix and re-used. After hydrocarbons and other substances in the form of liquids, as well as gas and vapors, are removed from the oil shale in the dynamic process matrix, the induction-hetable objects can separated from the matrix further re-used. The removed hydrocarbons can be transported and then sold or further processed. Spent oil shale may be removed for disposal, or heated to a high temperature in order to convert it to coke. The induction-heated objects preferably are not sacrificial and are not destroyed by the. Re-use of induction-heatable objects has economic advantages.

Referring to the figures, example embodiments of the inventions can be seen. The figures primarily focus on removal of marketable hydrocarbons from oil shale feedstock. The figures depict formation of a dynamic process matrix of oil shale feedstock and a plurality of induction-heatable objects. Heat transfers from induction-heatable objects in the matrix to feedstock particles in the matrix primarily by intimate contact and conduction. Radiant heating and convection may also play a role in heating the feedstock of the matrix. The matrix is dynamic because at different times, different particles of oil shale contact different induction-heatable objects for efficient heat transfer and uniform heating of the feedstock to a desired temperature. The matrix is a process matrix because it is processed in a retort to cause pyrolysis of the oil shale and extract usable hydrocarbons in the form of liquids and vapors that exit the feedstock of the matrix. Continuous movement of the dynamic process may be continuous or batch, as desired.

The induction-heatable objects used in the dynamic process matrix are heated by electromagnetic induction from passing through the interior of an induction coil prior to creating of the dynamic process matrix, during creating of the matrix, or after creation of the matrix. Electromagnetic induction primarily heats the induction-heatable objects by resistive heating and skin effect, although magnetic hysteresis may be employed as a secondary heating mechanism. Material composition of the induction-heatable objects, size and shape of the induction-heatable objects, thermal conductivity of the induction-heatable objects, size of the feedstock in the matrix, proximity of the induction coil to the induction-heatable objects, shape of the induction coil, and other variables are considered in order to optimize the invented methods and systems. Related invented equipment and systems are depicted.

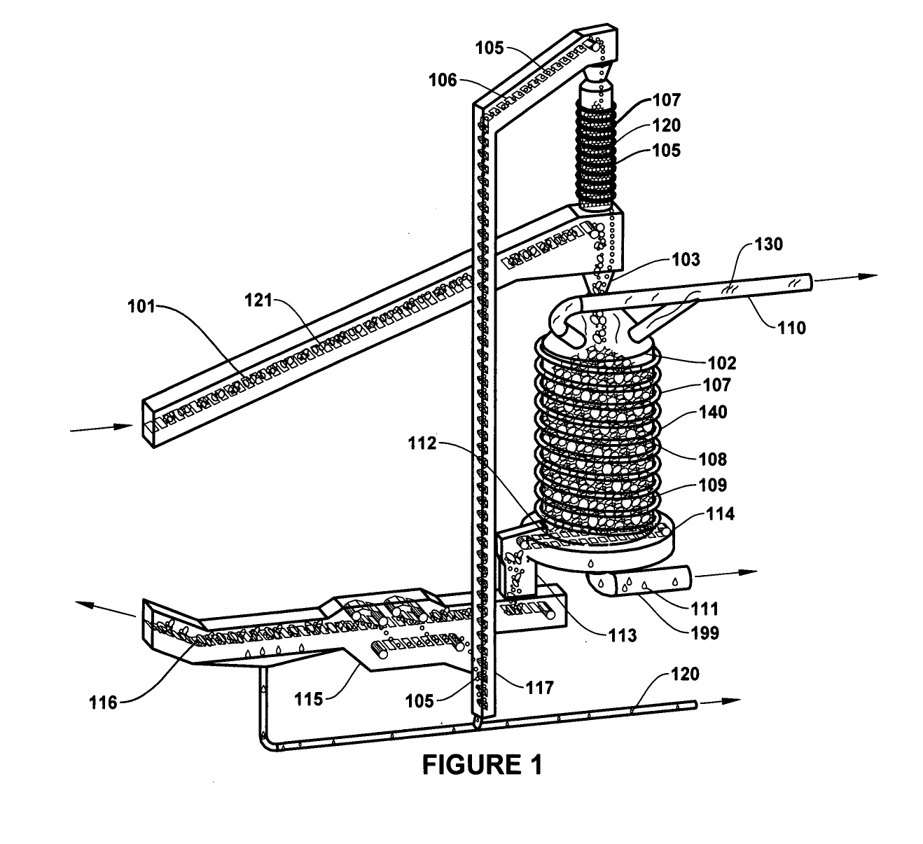

FIG. 1 depicts an oil shale processing system that uses one or more induction heaters to heat induction-heatable objects. The induction-heatable objects may be heated before or after mixing with oil shale feedstock to form a dynamic process matrix, or both. The dynamic process matrix includes a volume of oil shale feedstock intermixed with a plurality of movable induction-heatable objects. The oil shale feedstock and the induction-heatable objects reside in and/or travel together through a retort as a matrix. Retorting of the oil shale occurs when sufficient heat transfers from the induction-heatable objects to the oil shale in the matrix. Even distribution of heat throughout the oil shale feedstock in the dynamic process matrix is possible because at different points in time, different particles of oil shale are in intimate physical contact with different induction-heatable objects in the dynamic process matrix. In addition, heat may be transferred from one oil shale particle to another within the retort.

Referring to FIG. 1, an example implementation of the invention is shown. Oil shale feedstock 121 is transported to a retort 102 by an appropriate transportation means 101 (such as a conveyor or other material handling device). The retort 102 in this example is a vertically-oriented cylinder which utilizes gravity to move material downward as it is processed, although alternative retorts are possible within the scope of the inventive concept. The top of the retort has an input opening 103 through which oil shale feedstock 121 may be admitted. Prior to entry of oil shale feedstock 121 to the retort input opening 103, the oil shale feedstock 121 may be mixed with a plurality of induction-heatable objects 105 to form a matrix 108 of oil shale feedstock and induction-heatable objects. The mixing of oil shale feedstock and induction-heatable objects to form a matrix can occur before they enter the retort, as they enter the retort, or within the retort, as desired. The plurality of induction-heatable objects and the oil shale feedstock in the matrix are dynamic and movable with respect to each other in order to cause surface area contact between a single induction-heatable objects and more than one particle of oil shale feedstock within the matrix. The matrix is dynamic and movable with respect to the retort and with respect to the induction coil (discussed at greater length below).

In this example, the induction-heatable objects 105 are heated via induction heating in an appropriate location or chamber 120. They are heated to a desired temperature for use in the retort to cause pyrolysis of oil shale. The induction heating of the induction-heatable objects in the example of FIG. 1 may initially occur prior to formation of the matrix 108, although it could occur during formation of the matrix or after formation of the matrix. In this example, the induction-heatable objects are introduced to the induction-heating chamber 120 by a means for transporting 106 such material, such as a conveyor, pipe auger or other material handling device.

Thus, oil shale feedstock of a desired size may be mixed with a plurality of heated induction-heatable objects to form a dynamic process matrix prior to the matrix entering the retort. It is also possible to form the matrix within the retort. The induction chamber 120 may include or be surrounded by induction coils 107 and/or other structures appropriate to cause induction heating of the induction-heatable objects 105. In addition, once within the retort, induction coil 140 may be used to further heat the matrix or to keep it within a desired temperature range. As induction heating can occur very quickly, residence time of the induction-heatable objects in a retort can be very short, such as a few seconds or a few minutes. The matrix can reside in the retort on a stationary basis in a batch process, or the matrix can move through the retort without stopping in a continuous process. Gravity or powered means can move the matrix through the retort.

It should be noted that if the walls of the vessel in which the induction-heatable objects are heated is made from a conductive material, such as steel, then the vessel will heat via induction as well as create a shielding effect which minimizes heating of the induction-heatable objects within the vessel. This defeats one of the objects of the invention, which is to heat the heat the oil shale in the matrix by contacting them with heated induction-heatable objects, not by contacting them with an induction-heated vessel wall. Although it is possible to heat a retort wall and then contact oil shale feedstock with the hot wall, such as system would be an inefficient prior art conduction-through-a-wall system and that is not considered desirable in the invention. Further, although it is possible to heat induction-heatable objects before they enter a retort, and then heat the wall of the retort for additional heating by conduction-through-a-wall, such a process is likely wasteful of energy due to the cost of heating a large vessel wall as well as the inefficiency of heat transfer of conduction-through-a-wall systems.

Although heating of the induction-heatable objects by induction heating may be performed while the induction-heatable objects are stationary in a batch process, it is believed that greater efficiency will be achieved if the heating is performed on a continuous basis with the induction-heatable objects moving through an induction heater at the time that they are being inductively heated. A dynamic system such as this should speed processing and improve system throughput and efficiency. Further, it is believed that the inventions will yield the greatest efficiency if the induction-heatable objects are exposed to induction heating (at least in part) when present in a matrix and while the matrix is moved through the induction heater that is providing the induction heating. As induction heating heats the induction-heatable objects very quickly, it is not necessary to stop movement of the matrix within the coil in order to heat the induction-heatable objects in order to bring them up to a desired temperature, unless an underpowered induction heater is utilized. Also it is not necessary to stop movement of the matrix or render it stationary in order to expose it to expose to a magnetic field generated by and induction coil in order to keep them within a desired temperature range, i.e., to prevent the induction-heatable objects from cooling prematurely. Thus, dynamic relative movement of the matrix with respect to the induction coil while it is powered, or at least dynamic relative movement of the induction-heatable objects with respect to the induction coil, is expected in most embodiments of the invention. Nonetheless, the inventive concepts could be applied in other ways. For example, if the operating conditions of a particular system require a long residence time within a retort, then the matrix might be stationary for at least some of the induction heating. Alternatively, if relative movement of the induction-heatable objects or matrix with respect to a coil is achieved by a movable coil, then the induction-heatable objects or matrix could be stationary.

As depicted in this example, the matrix 108 resides stationary or dynamically (moving) in the retort 102, within the retort chamber 109, for a period of time necessary to retort oil shale and extract oil from the oil shale in the matrix. Within the retort, heat is transferred from the plurality of induction-heatable objects to the oil shale to cause pyrolysis. Some dynamic movement of induction-heatable objects with respect to oil shale within the matrix will aid in more rapid heat transfer and more even heat distribution. During the residence time of the matrix 108 within the retort chamber 109, liquid oil 111 will tend to drain from the oil shale, and can be collected and transported by a conduit 199 or other means to a location for further processing or sale. Also, hydrocarbon vapors 130 will exit the oil shale and may be collected by a vapor collection apparatus 110 for further processing, such as condensation, and sale.

Research by the inventors indicates that when an induction heating system is used to cause pyrolysis of oil shale, residence of oil shale in the retort can be from 20 minutes or less to an hour, or longer, although different embodiments of the invention can lead to different residence times. Ultimately residence times could vary from a few seconds to a few hours or longer depending on the combination of parameters employed.

The temperature of the induction-heatable objects and the oil shale can be any temperature chosen to optimize the particular embodiment of the invention. The inventors have found that heating the induction-heatable objects to a range of 700 to 1100 degrees Fahrenheit provides efficient pyrolysis of oil shale. Temperatures as high as 1200 degrees Fahrenheit or more are possible, although degradation of the hydrocarbon products removed from oil shale may occur at higher temperatures. Some of the gases contained in the oil shale begin to be liberated at temperatures as low as 350 degrees Fahrenheit. Nearly all of the products produced in the pyrolysis reaction occur at less than 1000 degrees Fahrenheit.

It should be noted that the induction coil can experience significant temperature increases when powered, so it may be desirable to circulate a coolant through the interior of the induction coil, or to otherwise take steps to keep the temperature of the induction coil within a desired range.

Retorted or spent oil shale and induction-heatable objects 112 in the dynamic process matrix can exit the retort chamber through an exit opening 113. An appropriate device such as a conveyor or other material handling means 114 may be used to facilitate material removal from the retort. Spent oil shale and induction-heatable objects may then be processed through a separator 115. Separated spent oil shale 116 may then be removed for disposal or other handling, and separated induction-heatable objects 105 may be returned by an elevator 117 or other material handling device to the conveyor 106 for re-use, or may be otherwise disposed of. Additional liquid products from the oil shale 120 can also be removed at this point.

In the system just discussed, the induction-heatable objects may be heated prior to introduction to the retort. As an alternative, the induction-heatable objects can be pre-heated prior to placement in the retort by coil 107, but can be further heated within the retort by coil 140. Or the induction-heatable objects can be heated to a desired temperature prior to placement in the retort, and then kept within a desired temperature range within the retort by powering coil 140 continuously or periodically. That further heating or keeping of the matrix within a desired temperature range inside of the retort is achieved in this example by induction heating. In this variation of the embodiment of FIG. 1, induction-heating apparatus 140 such as a coil around or within the retort or an electromagnet can be used to provide energy to the induction-heatable objects 105 within the matrix 108 that is inside the retort, thus heating those induction-heatable objects further, or simply keeping the induction-heatable objects 105 within a desired temperature range until desired heat transfer from the induction-heatable objects to the oil shale occurs. Alternatively, heating of the induction-heatable objects outside of the retort can be omitted, and induction-heatable objects maybe heated by induction heating exclusively within the retort. The particular implementation of the inventive concepts will dictate these or other variations and shall be considered to be within the scope of the inventive concepts.

In example implementations of the inventive concepts, inductively-heatable objects could be heated prior, during, or after formation of a dynamic process matrix that includes the heated induction-heatable objects and oil shale feedstock. The dynamic process matrix is permitted to reside in or travel through a retort for a period of time. While in the retort, the matrix can be agitated, stirred or otherwise handled to cause dynamic relative movement and dynamic contact between induction-heatable objects and oil shale particles in the feedstock. Over time, different particles of feedstock contact different induction-heatable objects in order to enjoy heat transfer via conductance from such induction-heatable objects. As a result of this heat transfer within the retort, pyrolysis of the oil shale may occur and desired hydrocarbons can be collected from the oil shale.

However, in some embodiments of the inventive concepts, processing a quantity of dynamic process matrix through a single retort may not yield complete pyrolysis of the oil shale in the matrix. In that circumstance, it will be desirable to reheat the induction-heatable objects in the dynamic process matrix in order to cause pyrolysis to continue until as much of the hydrocarbon material trapped in the oil shale as possible is removed. There are several alternatives for achieving this. For example, the retort could have an induction coil around it for the purpose of reheating the induction-heatable objects in the matrix, or for keeping them within a desired temperature range.

If the retort is large in diameter orthogonal to the direction of material flow, however, the magnetic field created by the induction coil may not be sufficiently strong to heat induction-heatable objects deep within the retort due to distance between the induction-heatable objects and the induction coil. In this situation, induction-heatable objects in the dynamic process matrix could be re-heated as they exit the retort through a smaller diameter conduit and the dynamic process matrix then fed into another retort for pyrolysis to continue. If complete pyrolysis is not achieved in the second retort, then the induction-heatable materials could be re-heated yet again and fed into a third retort for further pyrolysis.

Alternatively, after the dynamic process matrix exits the first retort, re-heating of the induction-heatable objects in the dynamic process matrix can be performed, and the matrix can be fed into the first retort again for further pyrolysis of the oil shale in the matrix. This process can be completed the number of times necessary to reach desired completion of pyrolysis of oil shale in the dynamic process matrix.

In the example where the dynamic process matrix is moved from a first retort to a second retort for further pyrolysis of oil shale within the matrix, the induction-heatable objects can be re-heated just before they enter the second retort, such as at the top of a vertical retort, or at the side of a horizontal retort. Another option is to re-heat the induction-heatable objects in the matrix while they are being transported from one retort to another, or as they are being moved from a retort exit to the entrance of the same retort. Such re-heating can occur while the matrix is on or in a material handling means, such as on a belt conveyor, on a screw conveyor, or in another material handling system. To perform such re-heating, the material handling system where the re-heating of induction-heatable objects are re-heated should be non-conductive in the region where the re-heating occurs. A simple solution to this problem is to interrupt the material handling system, such as screw conveyor, with a section of non-conductive conduit, such as polymer or composite pipe or other non-conductive conduit, and perform induction heating of the induction-heatable objects in or on that non-conductive conduit when the dynamic process matrix is on or in that section of conduit, either on a stationary or moving basis. Then the dynamic process matrix with re-heated induction-heatable objects can continue on/in the material handling system to a second retort or back to the original retort for further retorting of the oil shale and further collection of desired hydrocarbons that exit the oil shale.

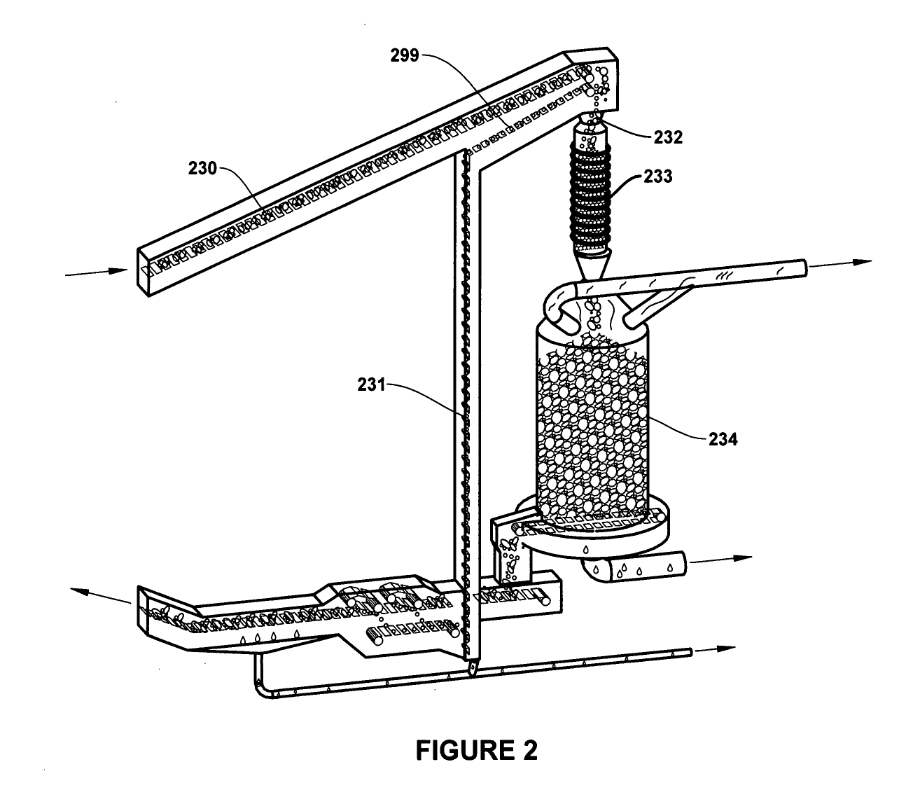

FIG. 2 depicts oil shale processing where a dynamic process matrix of oil shale and a plurality of induction-heatable objects moves into an induction heater where the plurality of induction-heatable objects in the dynamic process matrix are heated by electromagnetic induction. In this example, induction heating occurs after the matrix is created. Conductive heat transfer from the induction-heatable objects to the oil shale in the matrix begins at that point. Then the matrix is moved into a retort for full retorting of the oil shale via continued heating of the feedstock in the matrix by the hot induction-heatable objects. The plurality of induction-heatable objects and oil shale feedstock travel together dynamically through the induction heater and through the retort in this example, although stopping such movement for a batch process is possible.

Referring to FIG. 2, oil shale feedstock 230 and a plurality of induction-heatable objects 231 are mixed with each other to form a matrix 232. As the induction-heatable objects 231 are re-used from the prior retort of other oil shale, some recycling of heat can be achieved if the induction-heatable objects are returned to processing flow quickly enough. And if the induction-heatable objects are transported adjacent to the oil shale feedstock, such as in common pathway 299, heat from induction-heatable objects being recycled can pre-heat the oil shale feedstock prior to it entering the induction heater or retort, resulting in an energy savings.

The matrix 232 enters an appropriate induction heater 233 where the induction-heatable objects in the dynamic process matrix are heated by induction heating while the matrix is dynamically moving through the induction heater. Then the matrix 232 which now includes a plurality of hot induction-heatable objects passes into a retort 234 where heat from the induction-heatable objects transfers to the oil shale feedstock, causing pyrolysis. As the dynamic process matrix moves through or within the retort, dynamic relative movement of oil shale feedstock in the matrix with induction-heatable objects in the matrix is expected, and will help achieve even heat distribution. Removal of liquid hydrocarbon products, gaseous hydrocarbon products, the spent oil shale, etc. is performed as generally outlined for FIG. 1. It should be noted that if the induction-heatable objects are magnetic, then magnetic separation of the induction-heatable objects from the spent oil shale may prove very efficient. Exposing the retorted matrix to a magnet can remove the induction-heatable objects for their further use.

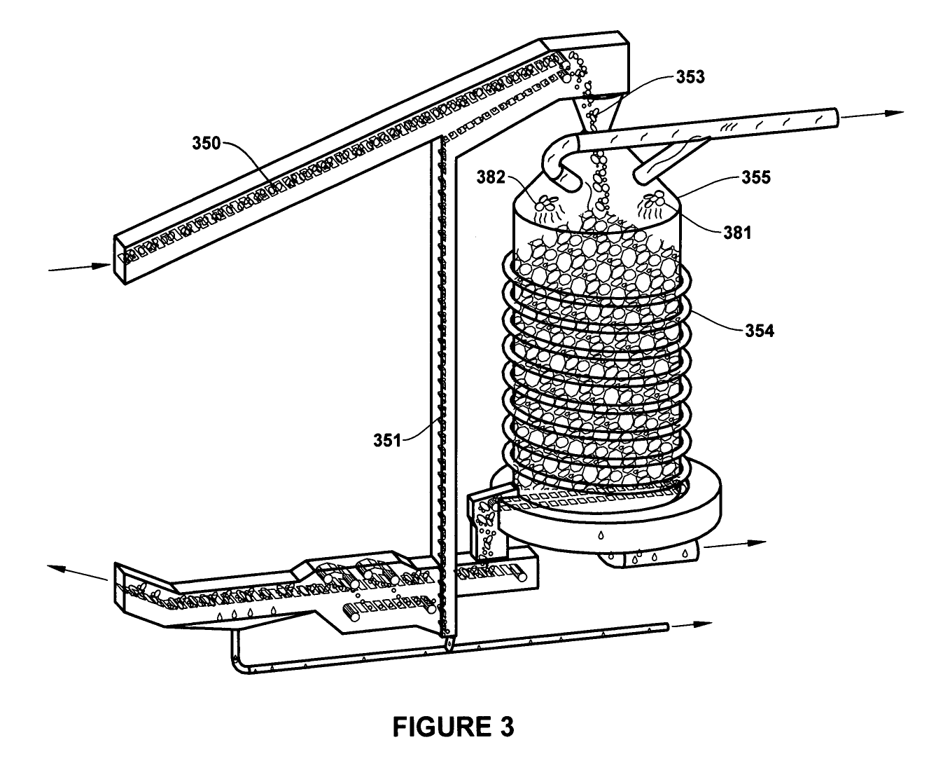

FIG. 3 depicts oil shale processing where a dynamic process matrix of oil shale feedstock and a plurality of induction-heatable objects is created and then placed into a retort for oil shale retorting. Within the retort, induction heating is used to heat the induction-heatable objects of the matrix so that they can transfer heat to the oil shale feedstock in the matrix. The oil shale feedstock increases in temperature and pyrolysis occurs. This facilitates removal of valuable liquid and gaseous hydrocarbon products from the oil shale. Note that some shared proximity of travel between oil shale feedstock and recirculated induction-heatable objects in this example tends to pre-heat the oil shale feedstock before formation of the matrix, and therefore conserves or recycles heat, consequently lowering the cost of energy inputs to the system. Pre-heating also allows reduction of time within the retort. Also note that the matrix can move dynamically through the retort while both heating and pyrolysis occur, which permits use of the inventions for continuous processing. If desired, the same general inventive concepts could be used to implement a batch system.

Referring to FIG. 3, another variation of the invention is depicted. In this example, oil shale feedstock 350 and a plurality of induction-heatable objects 351 are mixed to form a matrix 353. The matrix is introduced to the interior of a retort 355. Once inside the retort, induction heating means 354 is used to heat the induction-heatable objects. That heat is then absorbed by the oil shale feedstock in the matrix from the plurality of hot induction-heatable objects. The heated oil shale matrix resides in the retort an appropriate amount of time and pyrolysis occurs. The residence time in the retort may be dynamic, with the matrix slowly or quickly moving through the retort as pyrolysis occurs. Or it may be static, with the matrix residing stationary within the retort for a desired period of time. Valuable liquid and vapor hydrocarbon products and waste materials are removed, and the process can be repeated if it is a batch process, or continued if it is a dynamic process.

It is known that retorting oil shale creates hot gases within the retort. Those hot gases are a low-cost source of additional heat for the retort of oil shale if the hot gases are recirculated through the retort. Fans or blowers 381 and 382 represent optional means for recirculating gases within a retort, to improve heating by gas movement or circulation means. Although gaseous heating in general may not be an optimal solitary means for heating oil shale to cause pyrolysis, as long as hot gases are present within the retort, some heating benefit can be achieved my movement of such gases within the retort.

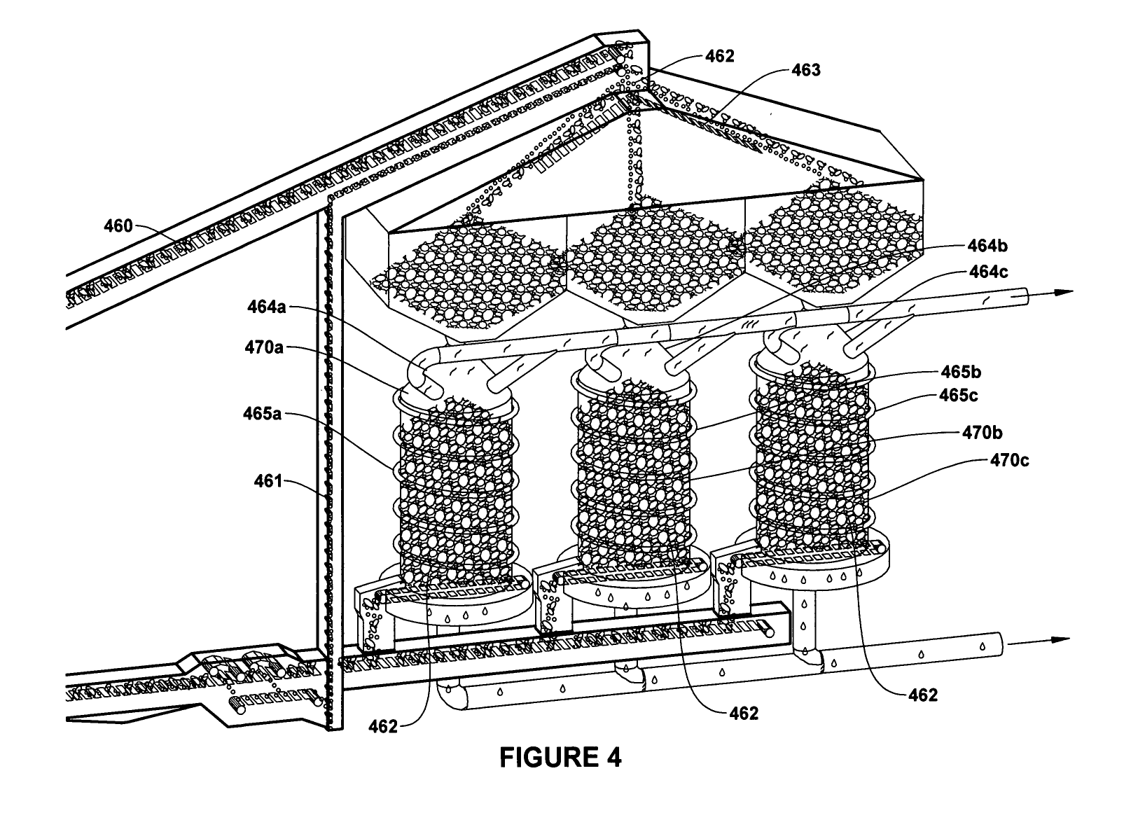

FIG. 4 depicts a variation on the concept of FIG. 3, where multiple retorts are used in parallel. Multiple smaller retorts can process the same amount of material as or more material than a single large retort, but often can be constructed more economically. In addition, it is possible to sort oil shale into different feedstock sizes and feed those sorted sizes into different retorts, with each retort being configures to maximize efficiency and effectiveness of retorting oil shale of that size.

Referring to FIG. 4, an embodiment of the inventions is shown that is similar in numerous ways to the example systems already mentioned above, but with some important differences. Oil shale feedstock 460 is mixed with a plurality of induction-heatable objects 461 to form a matrix 462. A distribution means 463 then distributes or allocates the matrix 462 among multiple retorts 464a, 464b and 464c. The retorts may include chambers 470a, 470b and 470c and may include appropriate induction heating equipment 465a, 465b and 465c. The induction-heating equipment serves to heat the plurality of induction-heatable objects found within the matrix 462 that is present in the retort chambers 470a, 470b and 470c. Heat transfers from the induction-heatable objects to the oil shale feedstock and pyrolysis occurs. Removal and separation of hydrocarbon products and waste materials may be performed as mentioned above or as otherwise desired. Although the embodiment depicted can be operated in batch processing mode, it is believed that operating it as a continuous process will be more efficient. If operated for continuous processing, the matrix will move through the induction coil dynamically as the coil heats the induction-heatable objects.

In another variation to this embodiment, the oil shale feedstock can be screened or separated into different size classes and then mixed with optimally-sized induction-heatable objects. Then each of the different sizes can be placed into its own separate retort specifically designed for processing that size material. This allows all parameters of the process to be set up to most efficiently heat and pyrolize the different sizes of feedstock.

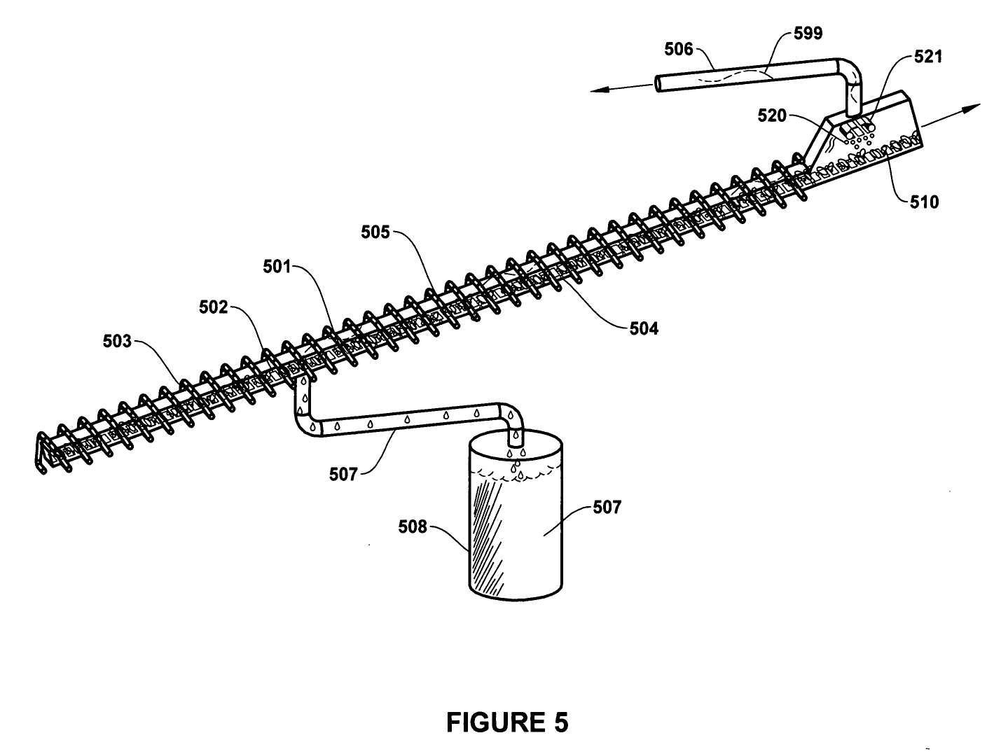

FIG. 5 depicts a system that continuously feeds a dynamic process matrix of oil shale and a plurality of induction-heatable objects through an elongate induction heater located around the exterior of a retort to cause pyrolysis of the oil shale. The matrix is fed through the retort by a material handling device such as a belt conveyor, screw conveyor, auger, or other appropriate material handling system. The induction coil used by the induction heater is designed and shaped to minimize space between it and the induction-heatable objects on or in the material handling system in order to increase efficiency of heating the induction-heatable objects. The induction coil may be shaped to accommodate the presentation of the dynamic process matrix offered by the material handling system. Depending on the implementation, a coil that is rectangular, trapezoidal, oval or otherwise shaped in cross section can be built. Other coil shapes may be used in order to locate the coil close to the dynamic process matrix. For example, if the dynamic process matrix is presented on a conveyor belt as a wide, flat flow of material, then a wide, rectangular coil could be used. If the dynamic process matrix is presented in a form that is circular or semi-circular in cross-section, such as through an elongate round conduit, then the coil could be round. A magnetic separator is used to remove induction-heatable objects from the matrix after pyrolysis and hydrocarbon removal have occurred. The induction-heatable objects can be re-used. Use of a continuous system such as this rather than a batch system can increase production of an oil shale processing facility.

In FIG. 5, a dynamic process matrix of oil shale and a plurality of induction-heatable objects has been created prior to its entry to a retort. The matrix 501 is located on a conveyor 502 such. A trapezoidal coil 503 is provided for induction heating the induction-heatable objects in the matrix. The conveyor causes the matrix to move through the shaped coil. Oil shale retorting occurs and desired hydrocarbons can be recovered.

As the induction-heatable objects within the dynamic process matrix pass through the coil, if the coil is powered, the induction-heatable objects heat up. In turn, heat is transferred from the heated induction-heatable objects to the oil shale in the matrix and the oil shale is consequently heated, causing pyrolysis of the oil shale 504. This process may be performed within a confined region such as a retort 505. The retort 505 can include hydrocarbon vapor 599 collection means 506 and hydrocarbon liquid 507 collection means 508. A condenser or other apparatus for processing valuable gaseous hydrocarbons is omitted from the figure. Induction-heatable objects 520 can be recovered post-retort, such as by a magnetic separator 521. Spent oil shale 510 can be discarded.

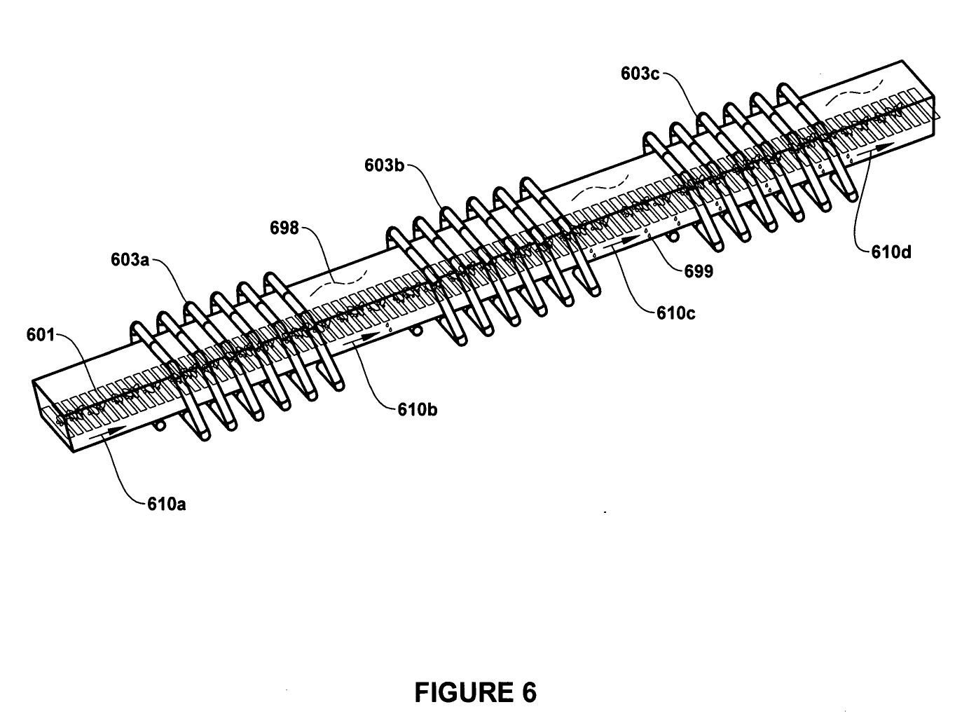

FIG. 6 depicts a system in which a dynamic process matrix of oil shale feedstock and a plurality of induction-heatable objects is moved through a series of separate induction coils, each designed to efficiently and controllably raise the temperature of the induction-heatable objects and thus the temperature of oil shale feedstock in the matrix. The series of coils can be used to step the temperature of the induction-heatable objects up to a desired target temperature through a series of heating steps. Or the first coil can heat the induction-heatable objects to a desired temperature while the remaining coils are used to keep the matrix within a desired temperature range for retorting the feedstock. Note that in this system the matrix dynamically moves through the coils as heating and retorting occur. Additional retorting may occur after the matrix exits the coils.

In the example of FIG. 6, the multiple coils of the system could be separated both by distance and/or by the interposition of retorts between them. This will allow re-heating of the induction-heatable objects in the matrix before the dynamic process matrix enters the second retort, or before the matrix enters the third retort, etc., or before the matrix re-enters the first and only retort. Re-heating may occur at the retort exit, at the retort entrance, or along the material handling system that transports the dynamic process matrix. Such embodiments of the inventive concepts can achieve complete pyrolysis in economical gravity-fed vertical retort system without having the retort be too tall, without re-heating the induction-heatable materials within the retort if the retort has too great a radius or circumference to make that practical, and without re-heating the induction-heatable materials in the matrix within the retort if the retort has conductive walls that would shield the induction-heatable materials from sufficient induction heating within the retort. Using a screw or belt conveyor between two or more retorts and interrupting the conveyor(s) with section(s) of non-conductive conduit surrounded by induction coil(s) where induction heating of the induction-heatable objects of the dynamic process matrix is performed may be the most practical implementation of the inventive concepts.

Referring to FIG. 6, a conveyor or other transportation means 601 moves a matrix of oil shale and induction-heatable objects through a series of stationary coils 603a, 603b, and 603c. Arrows 610a, 610b, 610c and 610d depict movement of the matrix through the stationary coils. If the coils are powered, then the induction-heatable within the matrix will be heated dynamically as the matrix moves. Heat will transfer to oil shale within the matrix, and pyrolysis will occur. Liquid 699 and gaseous 698 hydrocarbon products can be collected. The induction coils may be employed to step up the temperature of the matrix from a first cooler temperature, to a second warmer temperature, and then to a third hot temperature. Alternatively, one or more coils can be used to heat the matrix to a desired temperature, and subsequent coils can be used to keep the matrix within a desired temperature range to cause exit of valuable hydrocarbons from the oil shale. The coils can be shaped to cause them to be close to the induction-heatable objects within the matrix for heating efficiency. More than three coils can be used if desired, or only two coils can be used if desired.

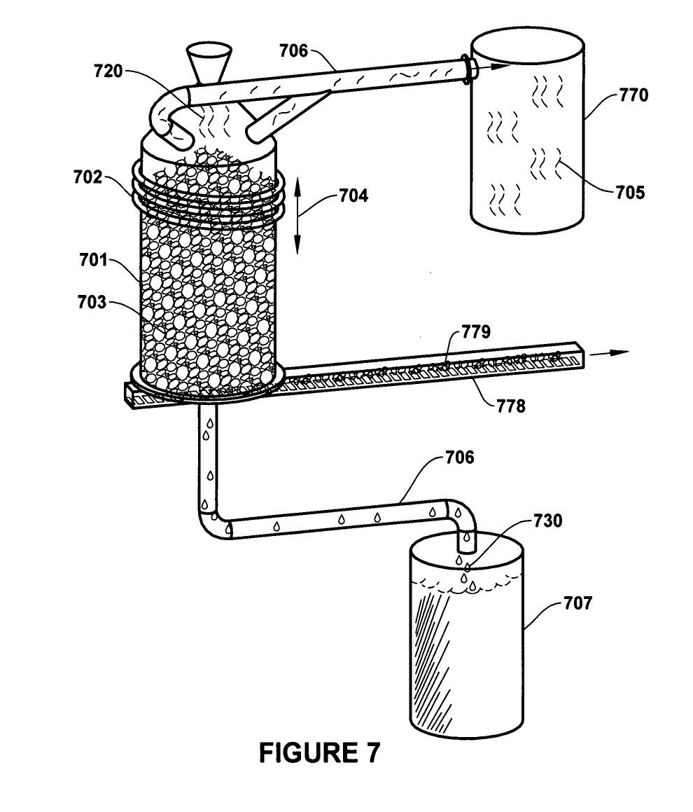

FIG. 7 depicts a system where a coil moves with respect to a stationary matrix of oil shale feedstock and induction-heatable objects. This is in contrast to other example implementations of the inventive concepts in which the matrix moves with respect to the coil instead of the coil moving with respect to the matrix. Alternatively the coil and matrix can be stationary with respect to each other and operated in a batch processing mode rather than dynamically in a continuous system.

Referring to FIG. 7, a vessel or retort 701 can be used to contain a quantity of oil shale and induction-heatable objects in a matrix 703. An electromagnet or coil 702 can be used to cause the induction-heatable objects within the matrix to increase in temperature. The coil 702 can be moved along the longitudinal axis of the retort in the directions shown by double-headed arrow 704. Moving the coil allows use of a smaller, less expensive coil, while still heating a large quantity of oil shale in one batch. The rate of movement of the coil with respect to the retort can be varied as desired. It can be varied dynamically depending on hot or cold spots within the retort if measurements of temperature of the oil shale, the inductive-heatable objects, or the matrix are taken. Liquid hydrocarbons 730 may be removed from the retort through a liquid hydrocarbon removal means 706 and stored in an appropriate vessel 707. Hydrocarbon vapors 720 can be removed from the retort through a gaseous hydrocarbon removal means 706 and placed in a vessel 770 where they can condense 705. Spent shale 779 can be removed by an appropriate removal means 778. The process can be repeated.

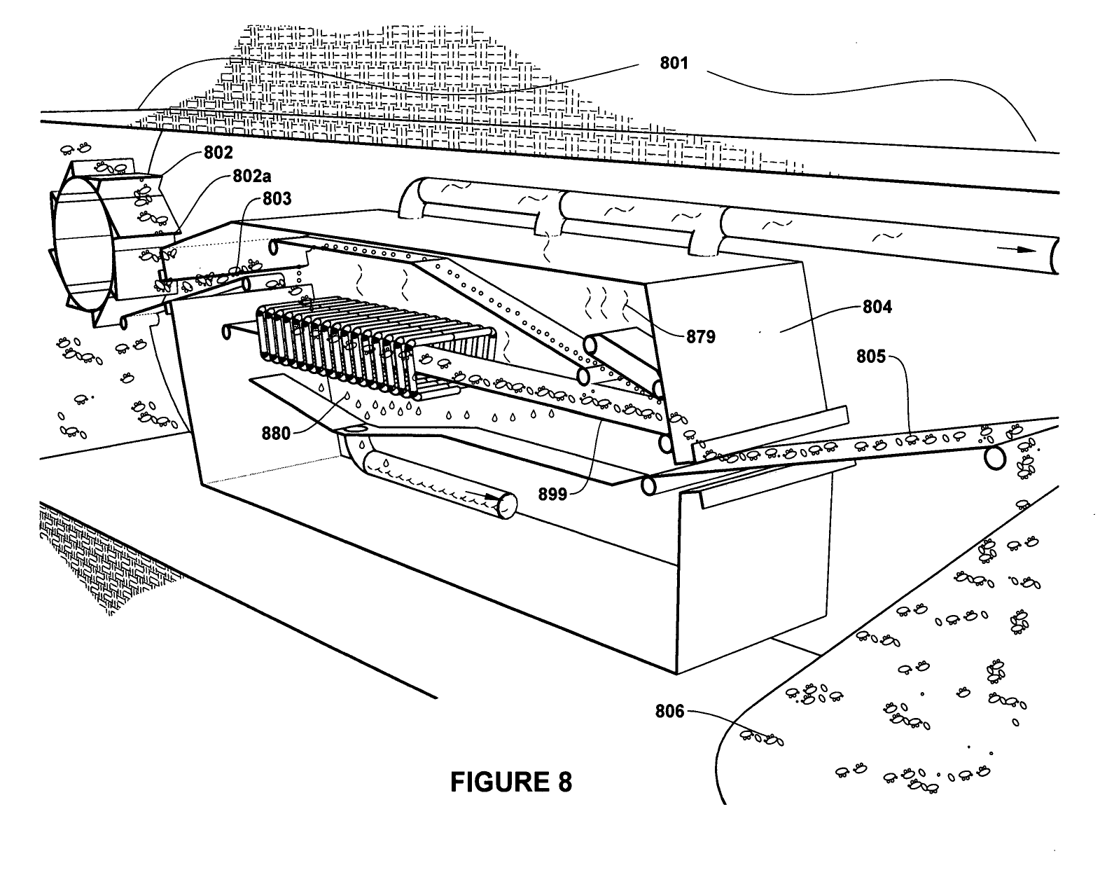

FIG. 8 depicts another embodiment of the inventions. This embodiment implements some of the inventive concepts for in situ processing of oil shale by use of a mobile oil shale removal and retort system 801. In this example, a mining apparatus 802, such as a longwall mining machine, is used to access an underground deposit of oil shale. The mining apparatus 802 can include means for horizontal removal of oil shale 802a (projecting edge or teeth) and means for transport 803 of oil shale such as a belt conveyor, screw conveyor, auger, or other material handling device. The means for transport can be used to transport oil shale to a mobile retort 804. The retort can have an induction coil and a conveyor 899 for moving material through the coil. After processing, spent oil shale 805 may be transported away from the retort 804 and used to backfill 806 the underground room from which oil shale was removed for processing. Liquid hydrocarbon products 880 and hydrocarbon vapors 879 can be collected for further processing or sale.

In traditional longwall mining techniques, material is removed from an underground mine and transported to the surface, leaving empty rooms beneath the ground. However, roof supports are needed within the rooms to prevent the mine roof from descending or caving in, so pillars of valuable material are left in the mine for roof support.

When the invented mobile retort is utilized, oil shale can be removed from an underground formation, processed immediately on the site within the underground mine, and then spent shale can be used to backfill the room behind the retort, thus providing roof support. Consequently, fewer or no pillars of valuable material need be left in the mine. Only spent oil shale need be left behind, leading to a much higher recovery than in traditional room and pillar mines. Due to expansion, some spent oil shale will need to be transported to another location such as the surface for disposal.

The retort 804 can include the various features and capabilities discussed elsewhere herein. A matrix of oil shale and induction-heatable materials or objects can be created. The matrix can be heated by use of induction heating of the induction-heatable objects which in turn heat the shale. Heating can occur dynamically by moving the matrix through a powered coil. Heating of the oil shale causes pyrolysis. As a result of pyrolysis, valuable liquid and gaseous hydrocarbons are recovered. Spent oil shale is discarded.

Problems related to heat produced by the retort, heat in the spent oil shale, removal of some spent oil shale to the surface for disposal, and the possibility of fire due to gases present in the mine would need to be addressed for this system to be operational and safe. However, this embodiment of the invention permits possible beneficial changes in mine design or configuration.

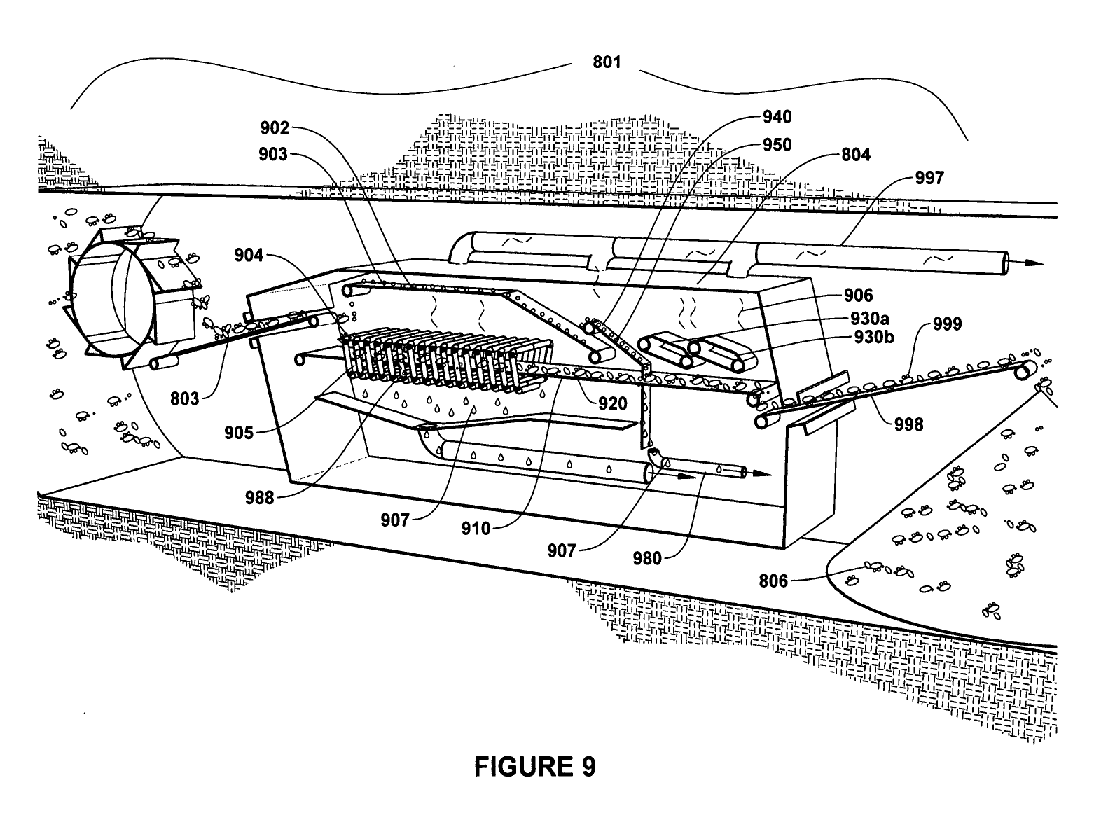

Referring to FIG. 9, greater detail about the retort 804 of FIG. 8 is provided. In this example, a horizontally-oriented retort 804 is utilized, although other retort configurations are possible within the inventive concept. A material input means 803 such as a conveyor moves oil shale feedstock to the front of the retort. An induction-heatable objects recirculating means 902 such as an elevator, auger, conveyor, etc. or a combination of them 902 of them brings induction-heatable objects 903 to a location where oil shale and induction-heatable objects are mixed for form a matrix 904.

The matrix 904 enters the induction heater 905 of the retort 804. The matrix 904 can be moved through the retort by a transportation means 910. The induction heater can include an electromagnet or a coil 988 which causes the induction-heatable objects to increase in temperature. Heat is transferred from the induction-heatable objects to the oil shale feedstock within the retort. Heated oil shale experiences pyrolysis and both liquid hydrocarbon products 907 and hydrocarbon vapors 906 are recovered.

The dynamic process matrix post-retort 920 may be exposed to magnetic separators 930a and 930b which remove the induction-heatable objects from the matrix post-retort 920 for re-use. Another transport means 940 may be used to recirculate the recovered induction-heatable objects 950. Additional amounts of liquid oil 907 may be recovered by a second liquid oil recovery means 980. Spent oil shale 999 is transported by a conveyor or other means 998 to a backfill area. Also, hydrocarbon vapors 906 are collected by a collection means 997 for further processing, use or sale.

The continuous mining machine with mobile retort may be a cost-effective long-term solution to the oil shale dilemma. Mining costs will be low, wasted material left for roof supports will be eliminated, transportation costs for mined oil shale will be almost non-existent, and there will be little surface disturbance. By implementing the mobile underground retort, oil shale may be completely mined, processed to remove usable oil, and much of it returned to an in situ location in a continuous or batch process. However, problems mentioned above should be addressed for safe and practical implementation of this embodiment of the invention.

The invention described above in various example embodiments has a number of distinct advantages over other prior art technologies for processing of hydrocarbon-containing materials. First, the invented techniques are very efficient from an energy use standpoint. Many prior art heat sources for heating hydrocarbon-containing materials waste 70 to 90 percent of the energy used to heat the hydrocarbon-containing materials by allowing that heat to exit through a smokestack. With the invented technology, the inventors have seen energy use efficiency at about 89 percent, but greater efficiency is expected as the systems are optimized.

Another advantage of the invented systems and methods is a very fine degree of control over the temperature of the hydrocarbon-containing material being processed. In prior art technologies, controlling temperature was very difficult, resulting in either degradation of the hydrocarbons due to too much heat, or failure to recover valuable hydrocarbons due to too little heat. The inventions allow the induction-heatable materials to be heated to the desired temperature, and kept at that temperature for an extended period of time simply by turning the induction heater on periodically. In the experience of the inventors, the induction-heatable objects may be brought up to their desired temperature (caused to glow if desired) within just a few seconds.

Another advantage of the inventions is that the processing systems can be configured for continuous or batch processing, as desired. The invented processors are also scalable and easily multiplied for staged facility development. And the invented systems can be mobile, to allow them to move from site to site. All of this keeps capital expenditures low and controllable, in contrast with prior art systems.

Further efficiency can be achieved when the inventions are used because the retorts are of a size and layout that can be easily insulated to minimize heat loss to the atmosphere. In addition, a very high proportion of the energy used by the retort is converted to heat for retorting. And the overall energy requirements for the invented systems are significantly less than prior art technologies due to the very high thermal efficiency of induction heating.

Many prior art technologies which used indirect heating were very slow and inefficient. This is in part due to the low surface area of contact between the prior art heating device and the material being heated. With the invented systems and processes, the ratio of heating surface area to process material volume can be very high, much higher than in prior art technologies, by simply adjusting the ratio of induction-heatable objects in the process matrix.

Additional heating efficiency can be achieved with the inventions because the heating media can be recirculated at a high temperature. In such instances, only minimal additional energy can be required to bring the induction-heatable objects to the required temperature for retorting.

Another benefit of the invented systems and methods is that the product from the retort contains only desired hydrocarbon gases and fluids. Many prior art systems unfortunately mix those desired hydrocarbon outputs with burning waste from their heating processes resulting in a very dirty and hazardous product that is very costly to separate.

When the inventions are implemented, it is possible to use mass flow, or gravity, for much of the material movement, minimizing complexity and maintenance of structures required in the processing facility.

Further, the inventions can achieve a high level of control for tailoring heating rates and process temperatures through the retort vessel. This creates the possibility to control production rates of different constituents at different points within the retort vessel.

As can be understood from the discussions herein, mixing of oil shale feedstock with induction-heatable objects to create a matrix may be performed inside of or outside of the retort. Further, heating of the matrix may be performed inside of or outside of the retort. Induction heating equipment may be integral with the retort or separate. Mixing of materials to form a matrix and induction heating may be performed as continuous processes or in batch form. In the retort chamber the heated objects in the matrix transfer heat the shale material that surrounds them. As the temperature of the shale increases, retorting occurs.

Selection of the induction-heatable objects depends on several factors. One factor to consider in selecting induction-heatable objects is the surface area of contact between the induction-heatable objects and the oil shale feedstock. Generally, greater surface area of contact will yield more efficient heat transfer between the induction-heatable objects and oil shale feedstock. However, extremes may not be practical.

Using induction-heatable objects that are very small, such as 1/16 inch in greatest dimension or even microscopic in size can lead to several difficulties. For the purpose of discussion, such very small induction-heatable objects will be considered induction-heatable materials. This will include induction-heatable objects that are fines, shaving, filings, grains (like grains of sand), dust, or other particles under about 1/16 inch.

The first difficulty is that such small induction-heatable materials have little thermal mass, so they quickly cool when in conductive contact with oil shale feedstock. This cooling may occur too quickly, and the oil shale feedstock may not be heated sufficiently to pyrolize.

A second problem is that sorting the very small induction-heatable materials from spent oil shale feedstock after they exit the retort will be very difficult. Assuming a significant percentage of induction-heatable materials in the process matrix in an attempt to achieve effective retorting of oil shale, then removing the very small induction-heatable materials from the spent feedstock will require substantial agitation, mixing, turning or other movement of the spent oil shale in order to expose the many induction-heatable materials to a separation mechanism such as a magnet. This effort may be time-consuming or costly. It also may be ineffective. The alternative is to leave the induction-heatable materials with the spent oil shale for disposal. Leaving the induction-heatable materials with the spent oil shale for disposal may have undesirable environmental consequences, high processing costs due to inability to recycle the induction-heatable materials, and may pose difficult regulatory problems.

Another problem presented by use of very small induction-heatable materials in the matrix is that they may not create interstitial spaces within the matrix which permit either liquid and gaseous hydrocarbon products, or both, of pyrolysis to exit the matrix. The consequence would be creation of a thick mud-like slurry after retorting the oil shale. Such a slurry would need to be further processed in an attempt to first remove the desired hydrocarbon products from the slurry, and then to remove the induction-heatable materials from the spent oil shale. This may prove impossible. Some prior art methods which did not include induction heating but did produce a thick slurry of spent oil shale and hydrocarbons that the oil shale due to pyrolysis were inoperable because the hydrocarbons that exited the oil shale were not possible or practical to remove from the spent oil shale in the slurry. A similar problem would be expected if very small induction-heatable materials are used.

However, this does not mean that in all cases using very small induction-heatable materials in the scope of the inventive concepts will be impossible. In the future, the various processing issues may be solved, allowing use of very small induction-heatable materials in the invented processes. For the present embodiments of the inventions, the inventors believe that the induction-heatable objects should be ⅛ inch in greatest dimension or larger in order to achieve an efficient, workable system. Induction-heatable objects of such size are referred to herein as “induction-heatable objects”, while the smaller sizes are referred to as “induction-heatable materials”.

At the other extreme from very small induction-heatable materials use of very large induction-heating objects, such as those a foot in diameter or more, may not be practical. Such large objects are difficult to heat by induction heating. Also, depending the size of oil shale feedstock, they may not achieve desired maximum surface area of physical contact between induction-heatable objects and oil shale feedstock in the dynamic process matrix. As an example, a single round induction-heatable object that is a foot in diameter placed in a retort with a single piece of oil shale feedstock of similar size would have only point contact between each other, and heat transfer would be slow, inefficient and probably incomplete. Substantial temperature variation within the oil shale feedstock would exist, and some of the oil shale feedstock in the matrix may not reach an adequate temperature to pyrolize, resulting in waste of a valuable hydrocarbon resource. Material handling would also be both difficult as the process would require moving the large induction-heatable object with respect to the large oil shale feedstock in order to maximize physical contact between them for conductive heat transfer.

The designers of each particular facility will have an opportunity to optimize size of induction-heatable objects and oil shale feedstock for their particular application, within the scope of the invention. Some prophetic examples of induction-heatable objects and oil shale feedstock are as follow:

| Induction-heatable | | Oil Shale | |
|---|---|---|---|
| Objects Size (in.) | | Feedstock Size (in.) | |
| 1 | inch | 1 | inch minus (including fines) |
| ¾ | inch | ¼ | inch (including fines) |
| ¾ | inch | ¾ | inch (including fines) |
| ¾ | inch | ½ | inch minus |
| 0.5 | inch | ¾ | inch |
| 0.5 | inch | 0.5 | inch |
| ⅜ | inch | | fines |
| ⅛ | inch | ¾ | inch minus |
| ¼ | inch | 1 | inch minus |
| ¾ | inch | 1 | inch minus |
| ¾ | inch | 2 | inch minus |
| 1 | inch | 3 | inch minus |
| 1.5 | inch | 4 | inch minus |
| 0.5 | inch | 4 | inch minus |
| 0.5 | inch | 2 | inch minus |
| 0.5 | inch | 1 | inch minus |
| ⅝ | inch | 1 | inch minus (including fines) |
| 2 | inches | 0.5 | inch minus |
| 3 | inches | ¾ | inch minus (including fines) |
| 2 | inches | 6 | inch minus (including fines) |
| 6 | inches | 3 | inch minus (including fines) |

Fines can be included in the oil shale feedstock in many implementations of the inventive concepts because sizing of the induction-heatable objects and some particles of oil shale feedstock in the matrix create interstitial spaces in the matrix through which liquid and gaseous hydrocarbons can escape the matrix for collection. Processing only fines with induction-heatable objects in the matrix may be more difficult but not impossible.

Generally it may be best to use smaller oil shale particles rather than larger ones in order to keep interstitial spaces small or very small, so that efficient heat transfer from a single inductively-heatable objects to multiple particles of oil shale at the same time is achieved for more rapid heating of the oil shale feedstock in the matrix. This effect can also ensure more efficient heat distribution throughout the matrix. Smaller induction-heatable objects may provide better heat transfer while larger ones may provide better kinematics. Issues such as escaping liquids and gases and low permeability of the matrix should be considered in making a size selection of induction-heated objects as well as oil shale feedstock.

The designers of an implementation of an embodiment of the inventions can also consider matching a ratio of suitable induction-heatable object particle size with particle size of the hydrocarbon-containing feedstock. A vast array of size ratios is possible, with 1:1 up to 1:4 or down to 4:1 of the size of induction-heatable object to hydrocarbon-containing feedstock being typical. Size ratios outside of this range are still part of the inventive concept and will be chosen by designers of systems using the invented concepts when appropriate. Other size ranges possible are 1:8 of oil shale feedstock to induction-heatable objects to 8:1 of the same ratio. These are not to be considered limits of the inventive concepts, however.

Depending on the retort used, flow velocity, and any assisting agitation, stirring, forced gas, or circulation, the induction-heatable objects may also have a crushing or crumbling effect on the oil shale feedstock, breaking it up as materials move through the retort.

Taking this concept a step further, a ratio of amount of induction-heatable objects to oil shale feedstock in the retort can be determined by designers o such a system. Due to the widely varying conditions of oil shale at different deposits throughout the world, this ratio will need to be optimized for each application. However, some prophetic examples of ratios of induction-heatable objects to oil shale feedstock in a retort by volume are as follow: 50:50, 75:25, 70:30, 80:20, 90:10, 10:90, 20:80, 30:70, 25:75. Some prophetic examples of ratios of induction-heatable objects to oil shale feedstock in a retort by mass are as follow: 50:50, 75:25, 70:30, 80:20, 90:10, 10:90, 20:80, 30:70, and 25:75. The inventors have found excellent efficiency when oil shale and induction-heatable objects comprise 50%+ of the matrix, by volume. Greater percentages of induction-heatable objects by volume in the matrix are possible, such as 55%+, 60%+, 65%+, 70%+, 75%+, 80%+, 85%+, etc. Likewise, lesser percentages of induction-heatable objects by volume in the matrix are possible, such as 45%+, 40%+, 35%+, 30%+, 25%+, 20%+, 15%+, etc. Further experimentation will optimize these and other features of the inventive concepts.

Another factor to consider in presumably maximizing the surface area of contact between the induction-heatable objects and the oil shale feedstock is the geometry of the induction-heatable objects. Possible geometries include round, cubic, multi-sided, polygonal, egg-shaped, pellets, bars, rods, discs, finned objects, hexagonal shapes, flat-sided balls, flat-sided plates, chains, slugs, undulating curved surfaces, objects with projections on them, objects with holes through them, hollow or partially hollow objects, filings, fines, liquids, liquid suspensions or conductive gases. The designers of any particular facility utilizing the inventive concept can model the particular shape of induction-heatable objects that will be best for their application. A difficulty related to trapping of oil shale feedstock or spent oil shale within any holes in inductively-heatable objects of the matrix should be considered.

Another factor to consider in selecting induction-heatable objects for use in the invention is the heat transfer properties of the induction-heatable objects. A high thermal mass and a high heat transfer coefficient will tend to result in faster heating of oil shale feedstock, improving the efficiency of pyrolysis. Additionally induction-heatable objects with high thermal emissivity will also tend to result in faster heating of oil shale feedstock, improving the efficiency of pyrolysis. The designers of any particular facility utilizing the inventive concepts can model the particular induction-heatable objects' thermal and heat transfer properties that will be best for their embodiment of the inventions.

Another factor to consider in selecting induction-heatable objects is their durability. In order to achieve low cost operation of a retort, the induction-heatable objects can be re-used many times. Thus, they may be selected to be durable, hard, resistant to abrasion or erosion, resistant to corrosion, resistant to heat, resistant to impact, resistant to build-up of other materials, easily separable from the spent oil shale feedstock, compatible with the selected method of separation and not cost prohibitive.

Another factor to consider in selecting induction-heatable objects is the ease of separating them from spent oil shale as materials exit the retort. Some methods of separation to consider are magnetic separation, mechanical screening, floatation, centrifuges, spirals or cyclones or natural segregation due to movement and vibration.

As mentioned above, the induction-heatable material may be a fluid or liquid rather than solid objects. Gases might be considered as well. Such induction-heatable material may be mixed with oil shale feedstock in an appropriate ratio and then inductively heated to cause pyrolysis in a retort. This may be a way to maximize surface area contact of the induction-heatable materials with the oil shale feedstock. If the induction-heatable material is to be re-used, it can then be removed from the spent oil shale feedstock by a desired method such as evaporation and condensation. Alternatively, if the induction-heatable material is very inexpensive, such as electrically-chargeable water, then it could be discarded together with the spent oil shale feedstock. Or it could be evaporated into the atmosphere with no further remediation needed However, most embodiments of the inventive concepts are expected to use inductively-heatable objects that are solid, discrete objects.

Separate from the type and size of induction-heatable objects, and the nature and size of the oil shale feedstock, consideration must be given to the retort.

In one example, the retort may be a generally vertical cylinder with a generally hollow interior. Induction-heatable objects may be placed into the top of the retort with oil shale feedstock, and they are allowed to proceed down through the retort. Materials may be moved through the retort by gravity flow or with mechanical assistance. Removal of spent oil shale feedstock from the bottom of the retort will be necessary in order to permit continued flow of materials. If the particle size or density of the induction-heatable objects differs from the particle size or density of the oil shale feedstock, then oil shale feedstock and induction-heatable objects may proceed through the retort at different rates, and this must be considered in feeding materials to the retort. In most cases, however, it is expected that oil shale feedstock and induction-heatable objects will proceed through the retort at approximately the same rate, although that will not necessarily be the case in all implementations of the invention.

Relative movement of particles of oil shale feedstock and induction-heatable objects within the retort will result in more rapid heating of oil shale feedstock within the dynamic process matrix and more even heat distribution within the matrix for more efficient pyrolysis of oil shale. This relative movement gives the matrix its dynamic quality. Various types of relative movement between oil shale feedstock particles and induction-heatable objects may be achieve including by gravity flow, agitation, stirring, other mechanical assistance, shaking, vibration, or other methods.

As oil shale feedstock is heated within a retort at least by conductive contact with heated induction-heatable objects and caused to pyrolize, there will be both gaseous and liquid hydrocarbon products emitted from the oil shale feedstock. The gases emitted from the oil shale in the process matrix during pyrolysis can include methane, ethane, propane, butane, pentane and hexane along with hydrogen sulphide, nitrogen, ammonia and others. If desired, these gases can be captured from the retort and collected for sale or for use in powering generator(s) or other power systems used to heat the induction-heatable objects. In some situations, a portion of those gases may be saleable. Otherwise, they can be converted or remediated to eliminate the risk of environmental contamination prior to disposal.

As mentioned, the retort can be established with a generally vertical flow if desired, and assisted by gravity. However, vertical flow is not a necessary component of the invention. A retort may be constructed in a form that offers another flow orientation, such as a lateral flow of oil shale feedstock. In such a case, mechanical assistance, such as a conveyor, screw conveyor, rotating drum or other means, may be needed to move oil shale feedstock from one side of the retort to the other. Such retorts can be more costly to build and maintain than those which rely on gravity for material flow.

Great efficiency is expected when processing oil shale mixed with induction-heated objects in a retort instead of relying on a prior art method of heating the sides or bottom of the retort to transfer heat to oil shale and cause pyrolysis by a conduction-through-a-wall. However, it is possible to heat the sides or top or bottom (or all of them) of the retort if desired when a matrix of oil shale and induction-heated objects is used. This will provide a secondary heating effect on the oil shale, although the heating effect is expected to be inefficient. At least some of the walls of the retort are expected to be non-conductive if heating of the induction-heatable objects of the matrix is performed within the retort, because conductive walls on the retort would form a barrier to complete heating of the induction-heatable objects within the matrix. In such a case, the non-conductive walls of the retort are presumably non-metallic and may have a low coefficient of heat transfer, making conduction-through-a-wall even more inefficient.

And another consideration is the interior shape of the retort. The retort may employ interior shape variations to assist with agitation, mixing, circulation or flow of the material. For instance, perhaps a more simplistic design allowing gravity to move the material through a series of chutes or chambers which would mix the materials without other mechanical intervention.

Regarding sizing of the induction-heatable objects, initial experimentation suggests that greatest efficiency is achieved if all of the induction-heatable objects are of the same or similar size, although further experimentation could yield different results.

The voltage, current and frequency provided to the induction heater can be varied as desired and can be matched to the load properties of particle size and total mass of the induction-heatable objects to be used in a particular embodiment of the invention. The coil used by the induction heater should also be considered. Superior efficiency can be achieved if the coil is close to the induction-heatable objects, therefore presentation of the hydrocarbon-containing feedstock will influence coil design. Some considerations for coil design are shape, number of turns, size of coil, material of the coil (such as copper or other conductive materials), cooling of the coil such as by circulation of a liquid coolant, and others. Some possible coil shapes (in cross section) will include circular, oval, elliptical, square, rectangular, undulating, helical, annular, or otherwise.

The induction heater, coil or electromagnet will typically have a controller, and the controller can provide load matching ability, no-load power consumption, and control of variables mentioned above as well as others. In most instances, the controller is expected to include computing means and an electronic display.

Some parameters to consider in implementing a system which utilizes the inventive concepts include characteristics of the hydrocarbon-containing feedstock from which hydrocarbons are proposed to be removed. Some feedstock characteristics to consider are top size, size distribution, specific heat, thermal conductivity, hydrocarbon content, water content, percentage of feedstock in matrix with induction-heatable objects, and others. In addition, various oil shale from various parts of the world experiences pyrolysis at different temperatures, so temperature control and adjustment of the dynamic process matrix can be considered.

Regarding distance from the coil to the induction-heatable objects, as that distance increases, efficiency of the system decreases. Therefore the inventors believe that it will be typical for the distance between the coil and induction-heatable objects will be not more than 2 feet, or perhaps 1 foot or less. But other distances are possible depending upon the system. Due to the distance issue, presentation of the dynamic process matrix for induction heating of the induction-heatable materials may be rectangular such as on a wide, flat conveyor, U-shaped such as on a conveyor with curvature, or it could be round or curved such as in a pipe or a cylindrical retort.

When induction-heatable objects in a dynamic process matrix are heated by using an induction heater, it takes time for the temperature of the oil shale in the matrix to catch up with temperature of the induction-heatable objects. In fact, complete catch-up may never occur. It is desirable for this catch-up to happen as quickly as possible, but without shocking the reactions or overshooting a target temperature. The inventors have found that the smaller the particles of induction-heatable objects and the smaller the particle size of oil shale that is used, the faster this catch-up occurs. Likewise, it is desirable to quickly reach target temperature for the oil shale to retort, rather than having an extended ramp-up time.

During retorting of oil shale, it may be necessary to re-heat the induction-heatable objects. The inventors believe that turning the induction coil ON and OFF according to a square wave power input configuration, at full power, is the most efficient way to keep the matrix within a desired temperature range, although other possibilities exist as well.

During experimentation, the inventors tried 100 kHz, 50 kHz and 5 kHz induction heaters. Temperature of the matrix was brought to a desired level, such as 900 degrees Celsius. Temperature was held at that level. Induction-heatable objects such as ¾ inch and ¼ inch steel rod sections were used. Energy efficiencies from 60%+, 70%+, 80%+ and above 93% were observed. Other experiments showed even higher efficiencies.

In the discussion above, retorting of oil shale in situ or ex situ through induction heating has been addressed and falls within the scope of the invention. In addition, the inventive concept also applies to processing other unconventional hydrocarbons in additional to oil shale, such as heavy oils, tar sands and oil sands, in order to derive valuable hydrocarbon products from them. Of course tailings from prior mining operations can also be processed with the invented machines, systems and methods.

Other sources of hydrocarbons may also be processed using the invented systems, machines and methods. For example, coal may be mixed with induction-heatable objects to create a matrix and the matrix can be inductively heated. Heating of the coal in this manner has several benefits. First, liquid oil and valuable gaseous hydrocarbons are removed from the coal and can be sold. Second, the coal is dewatered and upgraded to a higher BTU per pound of product. The coal processed in this manner will burn hotter and cleaner than untreated coal, resulting in more power produced by a coal fired power plant burning such coal, as well as greatly reduced emissions as a result of burning such coal. An induction heater may be placed on site at a coal-fired power plant to upgrade the coal before it is used by the power plant, which results in more power produced, valuable oil and gaseous hydrocarbons recovered, and less emissions from the power plant. Further, the heat used in this process is very inexpensively produced by the invented induction heating systems.

Similarly, the inventions may be used to convert coal to liquids, to convert coal to gas, or to coke coal.

Likewise, other materials that contain hydrocarbons can also be processed by the invented systems, methods and machines. For example, waste plastics, tires and other pollutants and be processed through a retort generally as described herein to derive valuable hydrocarbon products from them. In the case of tires, substantial amounts of carbon black and steel will also result from the process, and both of those products can be sold. In the case of tires, as tires typically contain steel, the tires can be shredded or chopped and then processed as a matrix without additional induction-heatable objects being introduced. Induction-heatable objects may be introduced into the used tire matrix if desired, or the metal already present can be relied upon to perform the desired heating function. Any of the inventive concepts disclosed herein can be used to process any of the aforementioned materials, or other materials.

Because the inventive concepts, systems, machines, processes and methods can be used to treat so many materials that contain hydrocarbons; the example drawings and text above showing the treatment of oil shale to remove desirable liquid oil and gaseous hydrocarbons from the oil shale should also be considered examples of similar removable of valuable hydrocarbons from any hydrocarbon-containing feedstock, and oil shale could be substituted for any other hydrocarbon-containing feedstock, such as tar sands, oil sands, coal, used tires, scrap plastic, other refuse, etc.

Many other uses for the invented machines, methods and systems also exist. For example, the inventions can be used to dewater coal, to dewater aggregate, or to dry pharmaceuticals. Other materials that can benefit from dewatering, drying, or heating using the invented processes, machines and systems include organic waste, grain, magnetite concentrate, lime, tailings of all types, any industrial process which requires heat, bauxite to calcite processing, soil remediation, smelting, material concentrating, production of phosphate, production of taconite pellets, production of cement, processing and re-processing of asphalt, wood coking, oil and gas processing, heavy crude heating, bitumen heating, heat treating of metal and other materials, carborizing, any generic heating, small static heating, large continuous heating, space heating, snow melting, snow removal, material pre-heating prior to an industrial process, PUG coking, fly ash treatment, lignite processing, and numerous others.

The inventors have discovered that smaller induction-heatable objects require higher frequency AC power input to the induction coil of the induction heater in order to achieve high energy usage efficiency. Efficiency of electricity to heat conversion using the invented methods, machines and processes has been as high as 88 percent and is expected to rise upon system optimization. To maximize heat transfer of induction-heatable objects to feedstock material (such as oil shale), at least fifty percent by volume of induction-heatable objects is believed to be desirable, but is not considered a limitation of the inventive concept. Retention time in the heating chamber is minimized by the rate of heat transfer from the induction-heatable objects to the feedstock increases with a higher percentage by volume of induction-heatable objects as well as smaller feedstock particle size. The inventors have found that the inventive concepts, including the induction heating feature, are very adaptable, tunable and controllable to accurately achieve and maintain specific desired material processing conditions. Accuracy of heating that was previously unachievable is possible with the inventions.

While the present devices and methods have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

1. A method for removing hydrocarbons from oil shale comprising the following steps:
obtaining a quantity of oil shale feedstock,
obtaining a plurality of induction-heatable objects that are heatable by induction heating and are at least ⅛ inch in greatest dimension,
mixing said oil shale feedstock with said induction-heatable objects to form a dynamic process matrix,
placing said dynamic process matrix into a retort,
heating said induction-heatable objects in said dynamic process matrix in said retort by induction heating,
said heated induction-heatable objects being caused to be in heat-conductive contact with at least some of said oil shale feedstock in said dynamic process matrix,
transferring heat from said induction-heatable objects in said dynamic process matrix to said oil shale feedstock in said dynamic process matrix by thermal conduction in order to heat at last some of said oil shale feedstock in said dynamic process matrix,
allowing relative movement between said heated induction-heatable objects and said oil shale feedstock in said dynamic process matrix to cause different particles of oil shale feedstock in said dynamic process feedstock to be in conductive-contact with different induction-heatable objects at different times,
causing pyrolysis of at least some of said oil shale feedstock in said dynamic process matrix to occur in said retort,
allowing hydrocarbons to exit at least some of said oil shale feedstock in said dynamic process matrix in said retort as a result of said pyrolysis, and
recovering hydrocarbons from said retort.

2. A method as recited in claim 1 wherein said induction-heatable objects are present in said matrix in a percentage that is at least 50 percent by volume.

3. A method as recited in claim 1 wherein at least one of said induction-heatable objects in said matrix is each on ¾″ or less in maximum dimension, and wherein a plurality of said induction-heatable objects are at least ⅛ inch in maximum dimension.

4. A method as recited in claim 1 a plurality of said induction-heatable objects are both resistive and conductive and are heatable by induction heating as a result of current induced in said plurality of induction-heatable objects by exposing them to a rapidly changing magnetic field.

5. A method as recited in claim 1 further comprising the step of magnetically separating inductive-heatable objects from spent oil shale said dynamic process matrix following pyrolysis.

6. A method as recited in claim 5 further comprising the step of recycling said separated induction-heatable objects and transporting them in close proximity with said oil shale feedstock to a location where said mixing step is performed in order to preheat said oil shale feedstock prior to creating said matrix.

7. A method for removing hydrocarbons from oil shale comprising the following steps:
obtaining a quantity of oil shale feedstock,
obtaining a plurality of induction-heatable objects that are at least ⅛ inch in greatest dimension and that are heatable by induction heating,
heating said induction-heatable objects by induction heating prior forming a dynamic process matrix of heated induction-heatable objects and oil shale feedstock,
mixing oil shale feedstock with said induction-heatable objects to form a dynamic process matrix,
placing at least some of said dynamic process matrix into a retort,
causing relative movement between said heated induction-heatable objects and said oil shale feedstock in said dynamic process matrix within said retort to cause different particles of oil shale feedstock in said dynamic process feedstock to contact different induction-heatable objects at different times,
transferring heat from said induction-heatable objects in said dynamic process matrix to said oil shale feedstock in said dynamic process matrix by at least thermal conduction in order to heat at last some of said oil shale feedstock in said dynamic process matrix,
causing pyrolysis of at least some of said oil shale feedstock in said dynamic process matrix to occur in said retort as a result of said transferring heat step,
causing hydrocarbons to exit at least some of said oil shale feedstock in said dynamic process matrix in said retort as a result of said pyrolysis, and
recovering hydrocarbons from said retort.

8. A method for obtaining hydrocarbons from oil shale comprising the following steps:
locating a deposit of oil shale in a formation,
operating a mining device underground in said formation to remove oil shale from its formation to create oil shale feedstock and to create an underground mine room,
transporting oil shale feedstock to a retort located in said underground mine room,
mixing induction-heatable objects with said oil shale feedstock to form a matrix,
placing said matrix into said retort,
induction heating said induction-heatable objects,
causing heat to be transferred from said heated induction-heatable objects to said oil shale feedstock in said matrix in said retort,
causing pyrolysis of said oil shale in said matrix to occur in said retort,
causing hydrocarbons to exit said oil shale as a result of said pyrolysis, resulting in spent oil shale,
recovering hydrocarbons from said retort,
removing said matrix from said retort,
separating said induction-heatable objects from said spent oil shale in said matrix removed from said retort,
backfilling at least a portion of said underground mine room with at least some of said spent oil shale.

9. A system useful for obtaining hydrocarbons from oil shale comprising:
a retort,
an induction coil located that is capable of creating a rapidly-changing magnetic field,
a power source for powering said induction coil,
induction-heatable objects that are at least ⅛ inch in greatest dimension, that are capable of being heated by said rapidly-changing magnetic field, and that are mixable with oil shale to form a dynamic process matrix,
said retort being capable of holding a quantity of said dynamic process matrix and being capable of permitting dynamic relative movement of induction-heatable objects and oil shale in said dynamic process matrix within said retort,
said induction-heatable objects being capable of conducting heat to oil shale present in said dynamic process matrix in said retort in order to cause heating of said oil shale which in turn causes pyrolysis of said oil shale and resulting in release of hydrocarbons from said oil shale in said retort, yielding spent oil shale in said dynamic process matrix,
means for removing hydrocarbons from said retort,
means for removing said matrix from said retort,
means for separating said induction-heatable objects from spent oil shale in said matrix after said matrix has been removed from said retort, and
means for disposing of spent oil shale.

10. A system useful for obtaining hydrocarbons from oil shale comprising:
a retort,
a dynamic process matrix that includes induction-heatable objects and oil shale,
said induction-heatable objects being both conductive and resistive,
an induction coil capable of creating a rapidly-changing magnetic field that is capable of heating said induction-heatable objects at least by resistive heating,
a retort capable of holding a quantity of said dynamic process matrix and which is capable of permitting relative movement of oil shale present in said matrix and induction-heatable objects present in said matrix that is in said retort,
said induction-heatable objects being capable of conducting heat to oil shale present in said matrix within said retort in order to cause at least partial pyrolysis of said oil shale,
means for removing hydrocarbons from said retort,
means for removing said matrix from said retort,
means for re-heating said induction-heatable objects, and
means for placing said matrix in a retort for further pyrolysis of said oil shale in said matrix after said re-heating step.

11. A method processing oil shale in order to receive valuable hydrocarbons from it, the method comprising:
mixing oil shale feedstock and induction-heatable objects to form a dynamic process matrix,
powering a coil that induces a current in at least some of said induction-heatable objects in order to cause them to increase in temperature to become heated induction-heatable objects,
causing at least some of said induction-heatable objects in said dynamic process matrix to contact at least some oil shale feedstock in said dynamic process matrix,
transferring heat from said heated induction-heatable objects to oil shale feedstock in said dynamic process matrix by conduction during dynamic movement of oil shale present in said dynamic process matrix and said induction-heatable objects present in said dynamic process matrix,
re-powering said coil in order to increase the temperature of said induction-heatable objects and place said dynamic process matrix within a desired target temperature range,
allowing at least some of said oil shale in said dynamic process matrix to retort,
permitting hydrocarbons to exit said oil shale as a result of said retorting, and
collecting at least some of said hydrocarbons.

12. A method processing oil shale in order to receive valuable hydrocarbons from it, the method comprising:
mixing oil shale feedstock and induction-heatable objects to form a matrix,
powering a coil that induces a current that creates a rapidly-changing magnetic field which in turn creates eddy currents in at least some of said induction-heatable objects in order to cause them to heat by ohmic heating,
causing at least some of said induction-heatable objects in said matrix to contact at least some oil shale feedstock in said matrix,
transferring heat from heated induction-heatable objects to oil shale feedstock in said matrix by conduction,
allowing at least some of said oil shale in said matrix to release hydrocarbons, and
collecting at least some of said hydrocarbons.

13. A method as recited in claim 12 wherein said at least some of said induction-heatable objects have an exterior geometry selected from the group consisting of round, cubic, cylindrical, oval, multi-sided, egg-shaped, pellet-shaped, bar-shaped, rod-shaped, disc-shaped, finned, hexagonal, flat-sided ball-shaped, plate-shaped, chain-shaped, undulating, curved, and shaped with projections.

14. A method as recited in claim 12 wherein at least some of said induction-heatable objects include a material that is selected from the group consisting of iron, steel, stainless steel, copper, aluminum, gold, silver, platinum, tungsten, zinc, nickel, lithium, tin, lead, titanium, carbon, graphite, and electro-ceramics.

15. A method as recited in claim 12 further comprising induction heating at least some of said induction-heatable objects at least in part by magnetic hysteresis.

16. A method as recited in claim 12 wherein said induction-heatable objects have a Curie temperature, and wherein said Curie temperature of said induction-heatable objects serves as an upper limit for heating of said induction-heatable objects.

17. A method for obtaining valuable hydrocarbons from a feedstock comprising:
obtaining a quantity of hydrocarbon-containing feedstock,
obtaining a plurality of induction-heatable objects that are mixable with said feedstock to form a dynamic process matrix,
said induction-heatable objects being resistive,
said induction-heatable objects being conductive,
a plurality of said induction-heatable objects being at least ⅛ inch in greatest dimension,
placing at least some of said induction-heatable objects within a coil,
powering said coil with alternating current,
creating a rapidly-changing magnetic field within said coil,
causing current to flow within said induction-heatable objects within said coil by operation of said magnetic field,
causing said induction-heatable objects which experience current flow to increase in temperature due to resistive heating,
causing rapid changes in the magnetic orientation of at least some of said induction-heatable objects by magnetic hysteresis,
causing said induction-heatable objects which experience rapid changes in magnetic orientation to experience an increase in temperature as a result of said rapid changes in magnetic orientation,
allowing at least some of said heated induction-heatable objects to come into physical contact with at last some of said feedstock in said dynamic process matrix,
allowing transmission of heat from at least some of said heated induction-heatable objects to said feedstock in said dynamic process matrix via heat-conductive contact with said feedstock,
allowing at least some of said feedstock in said dynamic process matrix to increase in temperature as a result of said transmission of heat,
causing at least some of said feedstock to release hydrocarbons from within it as a result of said increase in temperature, and
collecting at least some of said released hydrocarbons.

18. A method as recited in claim 17 further comprising the step of heating at least some of said matrix in the interior of another coil.

19. A method for removing hydrocarbons from a feedstock comprising the steps of:
mixing a feedstock of hydrocarbon-containing material with a plurality of induction-heatable objects to form a process matrix,
dynamically passing said dynamic process matrix through an electrically powered stationary electromagnetic coil that creates a rapidly changing magnetic field within its interior,
causing said magnetic field to induce a current in at least some of said plurality of induction-heatable objects,
permitting said current in said induction-heatable objects to cause at least some heating of said induction-heatable objects due to resistive heating to yield heated induction-heatable objects,
causing at least some of said heated induction-heatable objects to dynamically contact at least some of said feedstock in said dynamic process matrix,
causing at least some of said induction-heatable objects to transfer heat to at least some of said feedstock in said dynamic process matrix that they contact by conduction,
causing said at least some of said feedstock to increase in temperature as a result of said conduction,
collecting valuable hydrocarbons which exit said feedstock as a result of said increase in temperature.

20. A method as recited in claim 19
wherein at least some of said induction-heatable objects are greater than ⅛ inch in greatest dimension;
wherein at least some of said induction-heatable objects are less than 2 inches in maximum dimension;
wherein at least some of said induction-heatable objects are metallic;
wherein at least some of said oil shale feedstock includes particles that are less than 2 inches in maximum dimension; and
wherein said dynamic process matrix includes interstitial spaces within it which permit liquid oil and gaseous hydrocarbons to exit the dynamic process matrix.
